(19) United States
(12) Patent Application Publication
(10) Pub. No.: US 2011/0311345 A1
(43) Pub. Date: Dec. 22, 2011

(54) HIGH ROLL DENSITY FIBROUS STRUCTURES

(76) Inventor: Kevin Benson McNEIL, Loveland, OH (US)

(21) Appl. No.: 13/162,630

(22) Filed: Jun. 17, 2011

Related U.S. Application Data
(60) Provisional application No. 61/356,208, filed on Jun. 18, 2010.

(51) Int. Cl. D21H 27/02; B65G 49/00; B65G 65/00

(52) U.S. Cl. 414/800; 162/109; 162/114; 162/100

(57) ABSTRACT

A roll of fibrous structure. The fibrous structure can be embossed and have a basis weight of less than about 45 pounds per 3000 square feet. The roll can have a roll diameter greater than about 6.5 inches and a roll density of greater than about 0.09 grams per cubic centimeter. The roll can also have a dispensed to effective caliper ratio of greater than about 1.01.

### CROSS REFERENCE TO RELATED APPLICATION

This application claims the benefit of U.S. Provisional Application No. 61/356,208 filed on Jun. 18, 2010.

### FIELD OF THE INVENTION

The present invention relates to fibrous structures, processes for making such fibrous structures and sanitary tissue products comprising such fibrous structures.

### BACKGROUND OF THE INVENTION

Fibrous structures, for example sanitary tissue products such as paper and tissue paper are well known in the art. Such fibrous structures find widespread utility in the form of bathroom tissue (e.g., toilet paper), facial tissue and kitchen tissue (e.g., paper towels), which are collectively referred to as sanitary tissue products. Such fibrous structures are often provided on a roll for ease of dispensing by a user. For example, it is well known to provide paper towels on a roll, the roll being a continuous web of paper having periodic lines of perforation permitting the user to tear off and use individual sheets.

Consumers of rolled fibrous structures such as rolled paper products desire soft, smooth, and absorbent structures. Substrates utilizing “through-air-dried” (TAD) technology, for example, have enjoyed great consumer acceptance. Consumers also desire fibrous structures having aesthetically pleasing features such as embossing, and embossed fibrous structures and embossing processes are well known in the art. Consumers also desire rolls of paper products having a high sheet count, such as toilet tissue or paper towels having a greater web length such that a greater number of sheets (for a given sheet size) can be provided.

Rolls of fibrous structure comprising relatively high density sheets in relatively high density roll format are known. Likewise, rolls of fibrous structure comprising relatively low density sheets in relatively low density roll formats are known. Further, rolls of fibrous structure comprising relatively high density sheets in relatively low density roll formats are also known. However, consumers continue to desire more sheets and/or extended roll life of low density fibrous structures. In other words, consumers desire rolls of fibrous structure comprising relatively low density sheets in relatively high density roll formats.

In addition, consumers desire for the aesthetics, such as embossments, in their sanitary tissue products to be retained throughout the life of the product. For example, consumers desire the embossments to be retained and/or be resilient to forces, such as compressive forces, being applied to the embossments. Consumers desire the embossments to be retained to a great extend from the beginning of a new roll of sanitary tissue product to the end of the roll.

Unfortunately, providing a consumer with a high sheet count and/or extended roll life is complicated by the consumer's desire for aesthetic features such as embossments. Due to various user limitations such as space for enlarged roll sizes, the number of sheets (or length of the rolled web) consumers can utilize is also limited. A tightly wound roll of embossed paper towels, for example, can deliver more sheets per roll, but due to the requisite pressure on the web, tight winding results in flattening of embossments, reduction of sheet caliper, degradation of absorptive characteristics, and a general loss of other consumer-desired attributes.

Accordingly, there exists a need for a fibrous structure that can be wound on a roll having a relatively high roll density, and yet continue to exhibit consumer-acceptable dispensed sheet parameters, such as softness, strength, embossment clarity and/or embossment height, and absorbency rate and capacity.

Additionally, there exists a need for a roll of fibrous structure in which the fibrous structure can be wound to produce a relatively high roll density relative to prior art fibrous structures on a roll, but for which the fibrous structure retains consumer-relevant amounts of emboss clarity, absorptive capacity, caliper, softness, or the like.

Additionally, there exists a need to produce high density roll products of fibrous structures such as bath tissue or kitchen tissue that provide a consumer more product relative to prior art roll products but which can be utilized on existing dispensing devices.

Further, there exists a need for an embossed fibrous structure comprising one or more embossments, especially line art embossments that are resilient go forces being applied to the embossments, particularly when the fibrous structure is a sanitary tissue product in a roll format.

### SUMMARY OF THE INVENTION

The present invention fulfills the needs described above.

In one example of the present invention, a roll of fibrous structure is disclosed. The fibrous structure can be embossed and have a basis weight of less than about 45 pounds per 3000 square feet. The roll can have a roll diameter greater than about 6.5 inches and a roll density of about 0.09 grams per cubic centimeter. The roll can also have a dispensed to effective caliper ratio of greater than about 1.01.

In another example of the present invention, an embossed fibrous structure, for example a fibrous structure comprising a line embossment, exhibiting an emboss side wall angle of greater than 15° and/or greater than 20° and/or greater than 25° and/or greater than 30° and/or greater than 35° and/or greater than 40° and/or greater than 45° and/or greater than 50° as measured according to the Emboss Side Wall Angle Test Method described herein.

### BRIEF DESCRIPTION OF THE DRAWINGS

FIG. 1 is a chart showing dispensed versus in-wound caliper for substrate dispensed from rolls of fibrous substrate of the present invention;

FIG. 2 is a chart showing absorptive capacity for substrate dispensed from rolls of fibrous substrate of the present invention;

FIG. 3 is a chart showing absorbency rate for substrate dispensed from rolls of fibrous substrate of the present invention;

FIG. 4 is a representation of one embodiment of an embossment of the present invention;

FIG. 5 is a chart showing emboss depth for substrate dispensed from rolls of fibrous substrate of the present invention;

FIG. 6 is a partial cross sectional view of an embossing apparatus;

FIG. 7 is a partial cross sectional view of an embossing apparatus;

FIG. 8 is a partial cross sectional view of an embossing apparatus;

FIG. 9 is a perspective view of a male embossing roll;

FIG. 10 is a perspective view of a female embossing roll;

FIG. 11 is a side view diagram of a roll winding apparatus;

FIG. 12 is a diagram of a support rack utilized in the HFS and VFS Test Methods described herein;

FIG. 12a is a cross-sectional view of the portion of FIG. 12 indicated.

FIG. 13 is a diagram of a support rack cover utilized in the HFS and VFS Test Methods described herein;

FIG. 13a is a cross-sectional view of the portion of FIG. 13 indicated; and

FIG. 14 is a diagram of a CRT Test Method set up.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Nonlimiting examples of fibrous structures of the present invention include paper, fabrics (including woven, knitted, and non-woven), and absorbent pads (for example for diapers or feminine hygiene products).

Nonlimiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structure of the present invention can be produced in the form of a roll of fibrous structure, such as is common in the production of toilet tissue and paper towels. Rolled fibrous structures are typically supplied on a cardboard core. The fibrous structure of the present invention has particular utility in its ability to retain desired characteristics such as caliper, emboss clarity (wall angle and depth), and absorptive properties, after having been wound tightly into the rolled form.

The fibrous structure can be embossed, through-air-dried (TAD) paper having relatively low density in a web and rolled onto a roll having relatively high roll density.

The fibrous structure of the present invention may exhibit a basis weight between about 10 g/m² to about 120 g/m² or from about 15 g/m² to about 110 g/m² or from about 20 g/m² to about 100 g/m² or from about 30 to 90 g/m². In addition, the fibrous structure of the present invention may exhibit a basis weight between about 40 g/m² to about 120 g/m² or from about 50 g/m² to about 110 g/m² or from about 55 g/m² to about 105 g/m² or from about 60 to 100 g/m².

The fibrous structure of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the fibrous structure of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the fibrous structure exhibits a total dry tensile strength of less than about 394 g/cm (1000 g/in) and/or less than about 335 g/cm (850 g/in).

In another example, the fibrous structure of the present invention may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The fibrous structure of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The fibrous structure of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The fibrous structure of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

When rolled onto a core having an outside-to-outside core diameter of about 1.7 inches, such as is common with toilet paper and paper towels, the fibrous structure of the present invention may exhibit a roll density of at least about 0.09 grams per cubic centimeter (g/cc), or at least about 0.11 g/cc, or at least about 0.15 g/cc, or at least about 0.25 g/cc or at least about 0.35 g/cc or at least about 0.40 g/cc or at least about 0.42 g/cc.

The fibrous structure of the present invention may exhibit a total absorptive capacity according to the Horizontal Full Sheet (HFS) Test Method described herein of greater than about 10 g/g and/or greater than about 12 g/g and/or greater than about 15 g/g and/or from about 15 g/g to about 50 g/g and/or to about 40 g/g and/or to about 30 g/g.

The fibrous structure of the present invention may exhibit a Vertical Full Sheet (VFS) value as determined by the Vertical Full Sheet (VFS) Test Method described herein of greater than about 5 g/g and/or greater than about 7 g/g and/or greater than about 9 g/g and/or from about 9 g/g to about 30 g/g and/or to about 25 g/g and/or to about 20 g/g and/or to about 17 g/g.

The fibrous structure of the present invention may be in the form of fibrous structure rolls. Such fibrous structure rolls may comprise a continuous fibrous web having a plurality of sheets of fibrous structure, the sheets being joined by a line of perforation that permits each sheet to be separably dispensable from adjacent sheets. The lines of perforation are typically evenly spaced to provide for sequential dispensing of substantially equal-sized sheets, so that the lines of perforation can be described as periodic lines of perforation defining sheets of fibrous substrate. In one example, one or more ends of the roll of fibrous structure may comprise an adhesive and/or dry strength agent to mitigate the loss of fibers, especially wood pulp fibers from the ends of the roll of fibrous structure.

The fibrous structure of the present invention may comprise one or more additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, inks, dyes, and other types of additives suitable for inclusion in and/or on fibrous structure.

“Fiber” and/or “Filament” as used herein means an elongate particulate having an apparent length greatly exceeding its apparent width, i.e. a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Nonlimiting examples of fibers include wood pulp fibers and synthetic staple fibers such as polyester fibers.

Filaments are typically considered continuous or substantially continuous in nature. Filaments are relatively longer than fibers. Nonlimiting examples of filaments include meltblown and/or spunbond filaments. Nonlimiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” or “bath tissue” or “toilet paper” as used herein means a soft, low density (i.e. basis weight<about 0.15 g/cm3) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be wound upon itself about a core or without a core to form a sanitary tissue product roll.

“Kitchen tissue” or “paper towel” as used herein means a web useful as a wiping implement for absorbing and cleaning spills in the kitchen. Of course, paper towels find great utility outside of a kitchen as well.

“Basis Weight” as used herein is the weight per unit area of a sample, generally reported in lbs/3000 ft² or g/m².

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Roll diameter” as used herein means the diameter of a roll of fibrous structure, such a roll of paper towels or a roll of toilet tissue, measured according to the Roll Diameter Test Method described herein.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

A fibrous structure of the present invention can be rolled into a roll format familiar to consumers of toilet tissue and paper towels, but differing from prior art rolls in that the fibrous structure of the present invention can be rolled tightly to produce a roll of fibrous structure having a roll diameter of greater than about 6 inches, or greater than about 6.5 inches, or greater than about 7 inches, or greater than about 8 inches as measured by the Roll Diameter Test Method.

A fibrous structure of the present invention can be rolled into a roll format familiar to consumers of toilet tissue and paper towels, but differing from prior art rolls in that the fibrous structure of the present invention can be rolled tightly to produce a roll of fibrous structure having a roll density of greater than about 0.09 and/or greater than about 0.10 and/or greater than about 0.11 and/or greater than about 0.12 and/or greater than about 0.13 and/or greater than about 0.14 and/or greater than about 0.15 g/cc as measured by the Roll Density Test Method.

A fibrous structure of the present invention can be a paper web being wound into a roll of fibrous structure, the paper web having a basis weight prior to winding of at least about 20 or at least about 25 or at least about 30 to less than about 45 or to less than about 40 pounds per 3000 square feet, and the fibrous roll structure can have a roll diameter of at least about 6.5 inches or at least about 7 inches or at least about 8 inches, and a roll density of greater than about 0.09 and/or greater than about 0.10 and/or greater than about 0.11 and/or greater than about 0.12 and/or greater than about 0.13 and/or greater than about 0.14 and/or greater than about 0.15 g/cc.

A fibrous structure of the present invention can be a through-air-dried (TAD) paper web formed as a continuous web comprising periodic lines of perforation, as is known in the art of toilet paper and paper towels. The web can be wound to a roll diameter of less than about 6 inches or less than about 6.5 inches, or less than about 7 inches, or less than about 8 inches, and yet provide a web length of at least about 1000 or at least about 1200 or at least about 1400 or at least about 1800 or at least about 2000 or at least about 2200 or at least about 2400 inches. Further, a roll of fibrous structure having a web length of at least about 1000 inches or 1200 inches and can have a paper web having a basis weight of less than about 45 pounds per 3,000 square feet, and a ratio of dispensed caliper to in-wound caliper of at least about 1.01 or at least about 1.03 or at least about 1.05 or at least about 1.07.

A roll of fibrous structure of the present invention can have discrete sheets of paper product, each sheet defined by sequential periodic CD perforations (as is common on prior art toilet tissue and paper towel products), the roll having at least 100 or at least 120 or at least 140 or at least 150 sheets of at least 700 square centimeters each, or at least 140 or at least 170 or at least 200 sheets of at least 400 square centimeters each, or at least 450 or at least 475 or at least 500 sheets of at least 100 square centimeters each. In one embodiment a roll of fibrous structure can have sheets having an area of at least 90 square centimeters. In each case the paper can have a basis weight of less than about 40 pounds per 3000 square feet. In each case the paper can be embossed. In each case the paper can be TAD paper.

TAD and/or embossed fibrous structures are particularly desired by consumers of bath tissue or paper towels. The present invention being a roll of fibrous structure can provide TAD and/or embossed fibrous substrates in high density roll formats so that a consumer receives more relatively softer and relatively more absorbent paper (compared to non-TAD and/or non-embossed paper) per roll without exceeding a roll diameter that makes the roll unwieldy or unusable in a consumer's dispensing device. The present invention provides the TAD and/or embossed fibrous substrates on a high density roll such that upon dispensing by a consumer the paper product retains desired characteristics such as caliper, emboss clarity (wall angle and depth), and absorptive properties.

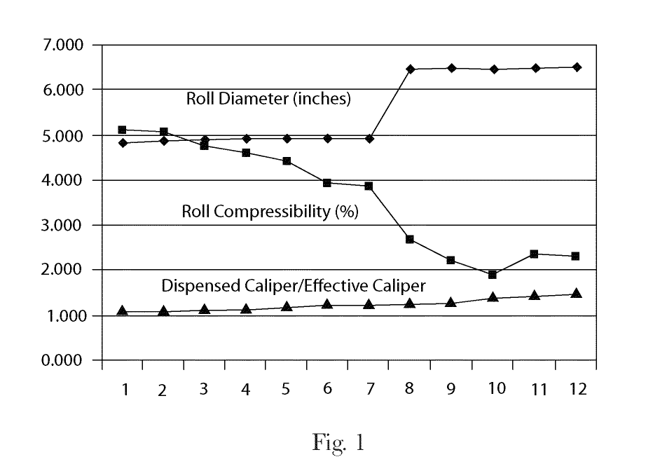

As shown in the graph of FIG. 1, a roll of fibrous structure of the present invention can exhibit fibrous structure properties including a dispensed to effective caliper ratio of at least about 1.01, as calculated by Effective Caliper Test Method and the Dispensed Caliper Test Method. This means that the fibrous structure of the present invention increases in caliper upon dispensing, relative to its in-wound caliper. Table 1 below shows the data set of FIG. 1, which data represent various roll and caliper properties for the same fibrous structure, which is 2-py TAD paper having a basis weight of about 28 pounds per 3000 square feet, and produced by use of rubber to steel embossing and hybrid winding, as disclosed more fully below. The substrate had wet burst strength of 300 grams as measured by the Wet Burst Test Method described below. The data of Table 1 and FIG. 1 show that a fibrous structure of the present invention can have a dispensed to effective caliper ratio of up to about 1.45. It is believed that the dispensed to effective caliper ratio can be higher with silicone or polyquat pre-treatment, as described more fully below.

TABLE 1
Roll versus Dispensed Properties

| Roll | Roll | Dispensed/ | | Effective |
|---|---|---|---|---|
| Diameter | Compressibility | Effective | Dispensed | Caliper |
| (inches) | (%) | Caliper | Caliper (mils) | (mils) |
| 4.827 | 5.112 | 1.07 | 31.433 | 29.408 |
| 4.883 | 5.052 | 1.07 | 30.433 | 28.473 |
| 4.907 | 4.756 | 1.08 | 29.500 | 27.304 |
| 4.927 | 4.600 | 1.11 | 29.100 | 26.219 |
| 4.913 | 4.410 | 1.15 | 28.633 | 24.821 |
| 4.917 | 3.933 | 1.21 | 28.667 | 23.776 |
| 4.917 | 3.866 | 1.20 | 27.233 | 22.751 |
| 6.467 | 2.681 | 1.22 | 27.300 | 22.422 |
| 6.483 | 2.210 | 1.26 | 27.133 | 21.580 |
| 6.480 | 1.903 | 1.36 | 27.967 | 20.631 |
| 6.493 | 2.361 | 1.42 | 28.233 | 19.882 |
| 6.513 | 2.303 | 1.45 | 27.900 | 19.216 |

The data of Table 1 also show that even at a roll compressibility as low as 1.9%, as measured by the Roll Compressibility Test Method, fibrous structures of the present invention can retain dispensed caliper greater than the effective in-wound caliper. Roll compressibility is inversely proportional to roll density. That is, as roll compressibility goes down, roll density goes up. Increasing roll density translates to providing more paper on a roll (on a per diameter basis) to consumers. Therefore, one benefit of the present invention is the ability to provide more product to the consumer on a roll having a diameter usable by a consumer, without a loss or degradation of properties such as dispensed caliper.

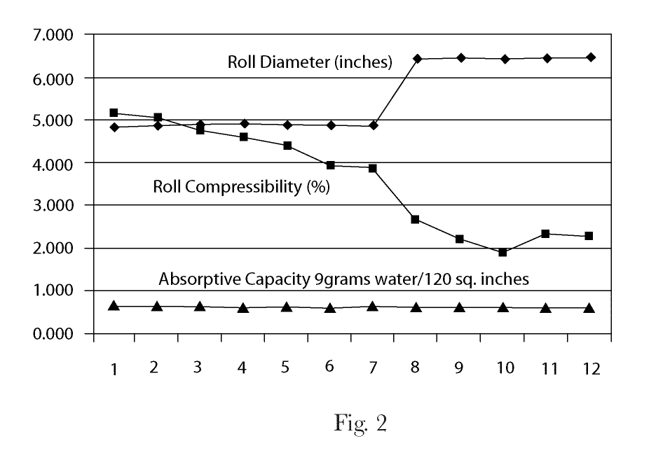

As shown in FIG. 2, a fibrous structure of the present invention can be provided in a high density roll format but which nevertheless retains its absorptive capacity nearly equivalent to the fibrous structure prior to winding onto a roll. Table 2 below shows the data set of FIG. 2, which data represent various roll and caliper properties for the same fibrous structure, which is the same TAD paper tested for the data of Table 1. The data of Table 2 and FIG. 2 show that a fibrous structure of the present invention can withstand being wound tightly onto a roll such that roll compressibility is as low as 1.9% without any appreciable loss to the absorptive capacity of the fibrous structure when dispensed from the roll. Absorptive capacity is measured according to the CRT Test Method, described below.

TABLE 2
Absorptive Capacity

| | | CRT Capacity |
|---|---|---|
| Roll | Roll | (grams |
| Diameter | Compressibility | water/121 |
| (inches) | (%) | square inches) |
| 4.827 | 5.112 | 0.621 |
| 4.883 | 5.052 | 0.624 |
| 4.907 | 4.756 | 0.614 |
| 4.927 | 4.600 | 0.604 |
| 4.913 | 4.410 | 0.628 |
| 4.917 | 3.933 | 0.594 |
| 4.917 | 3.866 | 0.641 |
| 6.467 | 2.681 | 0.632 |
| 6.483 | 2.210 | 0.621 |
| 6.480 | 1.903 | 0.626 |
| 6.493 | 2.361 | 0.619 |
| 6.513 | 2.303 | 0.619 |

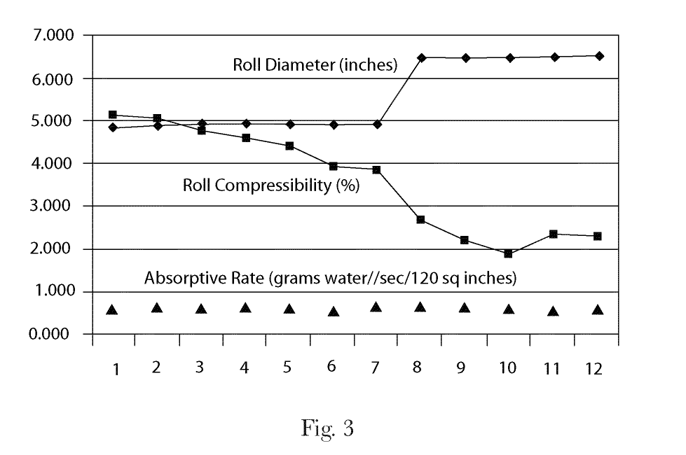

As shown in FIG. 3, a fibrous structure of the present invention can be provided in a high density roll format but which nevertheless retains its absorbency rate equivalent to the fibrous structure prior to winding onto a roll. Table 3 below shows the data set of FIG. 3, which data represent various roll and caliper properties for the same fibrous structure, which is the same TAD paper tested for the data of Table 1. The data of Table 3 and FIG. 3 show that a fibrous structure of the present invention can withstand being wound tightly onto a roll such that roll compressibility is as low as 1.9% without any appreciable loss to the absorbency rate of the fibrous structure when dispensed from the roll. Absorbency rate is measured according to the CRT Test Method, described below.

TABLE 3
Absorbency Rate

| | | Absorbency |
|---|---|---|
| Roll | Roll | Rate |
| Diameter | Compressibility | (g/water/sec/120 |
| (inches) | (%) | sq inches) |
| 4.827 | 5.112 | 0.602 |
| 4.883 | 5.052 | 0.635 |
| 4.907 | 4.756 | 0.624 |
| 4.927 | 4.600 | 0.650 |
| 4.913 | 4.410 | 0.618 |
| 4.917 | 3.933 | 0.542 |
| 4.917 | 3.866 | 0.664 |
| 6.467 | 2.681 | 0.669 |
| 6.483 | 2.210 | 0.641 |
| 6.480 | 1.903 | 0.620 |
| 6.493 | 2.361 | 0.565 |
| 6.513 | 2.303 | 0.619 |

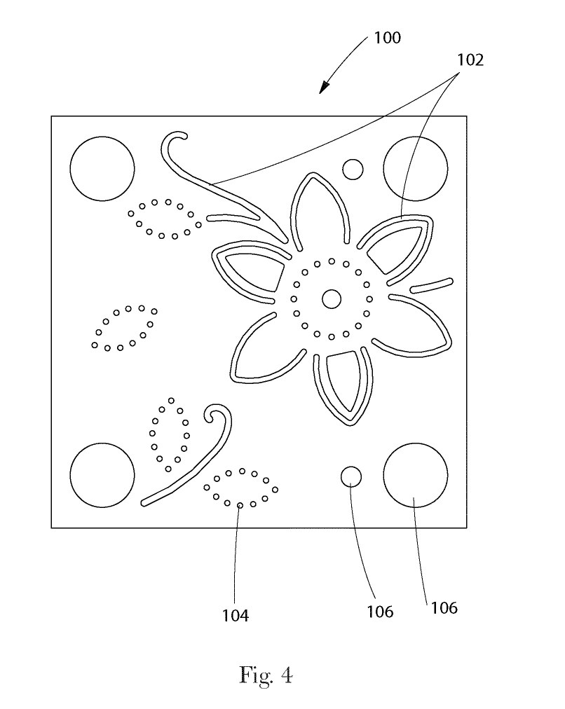

Emboss characteristics important to consumer-desired aesthetics include emboss depth and emboss wall angles. Both emboss depth and emboss wall angles are believed to contribute to a visual impression of emboss quality. Emboss quality of a fibrous structure of the present invention was determined based on an emboss pattern 100 as shown in FIG. 4. The emboss pattern shown in FIG. 4 includes at least three types of emboss typical in substrates used for bath tissue or paper towels. Specifically, as shown in FIG. 4, embossments can have line embossments 102, such as the petal portion of the emboss pattern of FIG. 4, small dots 104 and larger dots 106. In general, line embossments 102 are embossment for which length of the embossment is substantially longer than the width of the embossment. In the tested emboss pattern of FIG. 4, the width of the line emboss 102 is about 0.04 inches and can be from about 0.04 to about 0.06 inches in width. In general, small dot embossments can have a diameter (or longest dimension) of about 0.002 inch to about 0.10 inch. In the tested emboss pattern of FIG. 4, the diameter of the small dot emboss 104 is about 0.05 inches. In general, large dot embossments can have a diameter (or longest dimension) of about 0.10 inch to at least about 0.30 inch. In the tested emboss pattern of FIG. 4, the diameter of the small dot emboss 106 is about 0.17 inches.

Fibrous structures of the present invention can retain both a relatively high wall angle and a relatively deep emboss depth. Table 4 below shows emboss characteristics for three different embodiments of fibrous structures, each having the emboss pattern shown in FIG. 4 and made according to the method described in U.S. Pat. Nos. 7,687,140 and 7,704,601, each of which are hereby incorporated herein by reference. All samples were stored in flat sheet form for 3 weeks with a load on the samples of (200 grams or 400 grams per square inch) to emulate a range of compressive force that may be encountered in a wound roll of relatively high density. The samples were subsequently analyzed with the Embossment Depth Test Method and the Emboss Wall Angle Test Method, which analyzed the emboss structure topography after storage under load.

TABLE 4
Emboss characteristics

| Emboss | Emboss Side Wall Angles | | | | Emboss Depth | | | |
|---|---|---|---|---|---|---|---|---|
| Element | Control | | | | Control | | | |
| & Load | Sample | Sample A | Sample B | Sample C | Sample | Sample A | Sample B | Sample C |
| Line @ 400 g | 8.7 | 50.3 | 37.5 | 27.8 | 13.1 | 42.6 | 48.3 | 28.0 |
| Line @ 200 g | 6.7 | 34.5 | 71.2 | 27.1 | 8.7 | 49.2 | 41.0 | 26.8 |
| Small Dots @ | 35.8 | 32.5 | 50.0 | 29.6 | 17.0 | 31.8 | 48.3 | 28.5 |
| 400 g | | | | | | | | |
| Small Dots @ | 40.4 | 49.6 | 23.1 | 38.6 | 29.9 | 42.4 | 23.5 | 36.1 |
| 200 g | | | | | | | | |
| Large dots @ | 18.0 | 50.5 | 48.7 | 42.2 | 34.0 | 47.7 | 41.2 | 43.8 |
| 400 g | | | | | | | | |
| Large dots @ | 26.8 | 47.6 | 45.6 | 40.9 | 36.3 | 54.2 | 49.6 | 37.2 |
| 200 g | | | | | | | | |

As shown in Table 4, fibrous structures of the present invention include fibrous substrates that have been fluid treated after drying but before (or during) converting, such as before the embossing step. It has been surprisingly discovered that through the use of a fluid treatment during converting of the dried paper with chemicals such as steam, starch, silicone, polyquats, emboss quality can be dramatically improved in product rolled into a compressed, relatively high density roll format. Without being bound by theory, it is believed that such post-paper-making fluid treatment serves to modify existing hydrogen bonding between fibers, or create new adhesive bonds (including additional bonding aside from or additional to hydrogen bonding) between the fibers. Such bonds tend to act as springs, which upon release from compression permit the fibers to return toward pre-compression configurations. These chemical(s), when applied before the embossing process, appear to lock the fibers in the desired out of plane deformation (such as the pattern produced by embossing). The bonds remain flexible so that under compressive force they flex allowing the substrate to become flatter, thus allowing the winding of more sheets of substrate in a given volume than would be possible if the embossments did not compress.

An example of a class of chemicals that has been discovered to create this spring-like bond property are polyquats. There are many types of polyquats, including those known as PQ4, PQ6, and PQ11 and which are sold by Sigma Aldrich, BASF, and others. Polyquats have been added to papermaking processes in the so-called “wet end” for softening and cationic properties. However, in a TAD process it is well known that hygiene issues arise on the Yankee Roll of a papermachine when more than about 0.25% by weight of polyquat is added to the papermaking process. However, polyquats can be added in a converting process (after the drying process) at about 0.5% to 1% or more by weight to create spring-like bonds which preserve consumer desired emboss appearance. It is believed that polyquats have not been added in the converting process in the past, and they have not been used in the converting process for emboss preservation.

In one embodiment a polyquat, such as Poly(diallyldimethylammonium chloride) solution, commonly called PQ6, which can be ordered from Sigma Aldrich in various molecular weights ranging from <100,000 to ˜500,000, can be added on at 0.05%, or 0.1%, or 0.2%, or 0.3%, or 0.4%, or 0.5% or more. As the data in Table 4 shows, adding polyquat to dry paper during the converting process and before the embossing step has the surprising result of preserving emboss appearance. Samples A-C were treated prior to embossing with a hand-sprayed fluid add-on treatment of PQ6 at an add-on level before embossing of 5%, 10% and 15% respectively. As shown, fluid chemical treatment of the web prior to embossing served to preserve emboss wall angles to at least 27 degrees and above, and at high compression loads at about 200 gm/inch or about 400 gm/inch or more, and to preserve emboss height after the load is removed, particularly on line element embossing where widths are about 0.04 inches, as well as dots, particularly under higher loads of about 400 gm/inch.

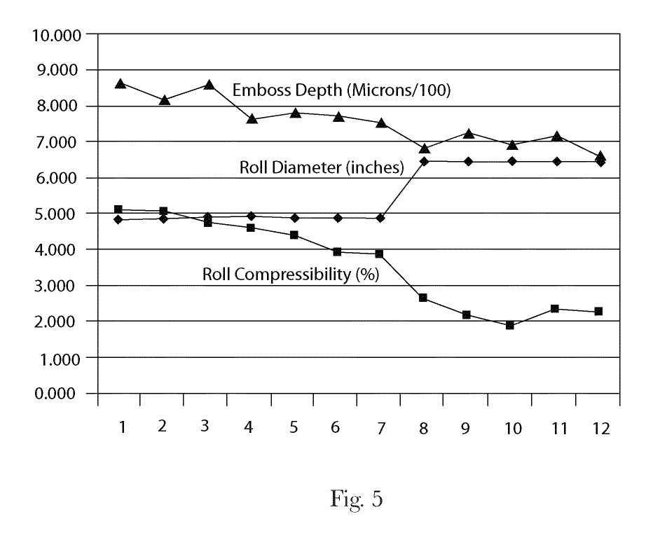

FIG. 5 shows data of an untreated (i.e., no chemical treatment, such as with polyquats) embossed fibrous structure wound onto a roll with varying roll diameter and roll density, and shows the emboss depth measured by a MikroCAD system after dispensing from the roll. As shown in FIG. 5, significant amounts of dispensed emboss depth are retained with increasing roll diameter and decreasing roll compressibility. The data shown in FIG. 5 is shown in Table 5 below.

TABLE 5
Emboss Depth with Decreasing Roll Compressibility

| | Roll | | |
|---|---|---|---|
| Roll | Compressibility | | |
| Diameter | (%) | MikroCad/100 | MikroCad |
| 4.827 | 5.112 | 8.66 | 865.667 |
| 4.883 | 5.052 | 8.20 | 819.667 |
| 4.907 | 4.756 | 8.62 | 862.333 |
| 4.927 | 4.600 | 7.66 | 766.000 |
| 4.913 | 4.410 | 7.84 | 784.333 |
| 4.917 | 3.933 | 7.74 | 774.333 |
| 4.917 | 3.866 | 7.57 | 756.667 |
| 6.467 | 2.681 | 6.84 | 683.667 |
| 6.483 | 2.210 | 7.28 | 727.667 |
| 6.480 | 1.903 | 6.93 | 693.333 |
| 6.493 | 2.361 | 7.19 | 719.000 |
| 6.513 | 2.303 | 6.62 | 662.000 |

The fibrous structures of the present invention are achieved by processing in a manner to impart relatively high caliper with relatively low density, and then wound onto a roll in a manner to provide a high roll density.

In one embodiment, high caliper and relatively low density is achieved by processing using TAD techniques as is known in the art. TAD can be combined with embossing to provide for low density, high caliper, and enhanced compression resistance.

### Embossing

Embossing can be achieved by use of the process described in co-pending U.S. Ser. No. 12/185,458 (US Publ. No. 2010/0028621 A1), entitled Embossed Fibrous Structures and Methods for Making Same, filed Aug. 4, 2008, which is hereby incorporated by reference herein. The process, referred to herein as “close tolerance embossing”, uses an embossing nip and patterned rollers as described below to impart embossments into a fibrous structure, which embossments have a depth and a wall angle that survive the flattening pressure of being rolled into a roll of fibrous structure of the present invention. Embossments can be made in single plies that are subsequently joined to make multi-ply paper as is known in the art.

### Embossing Nip

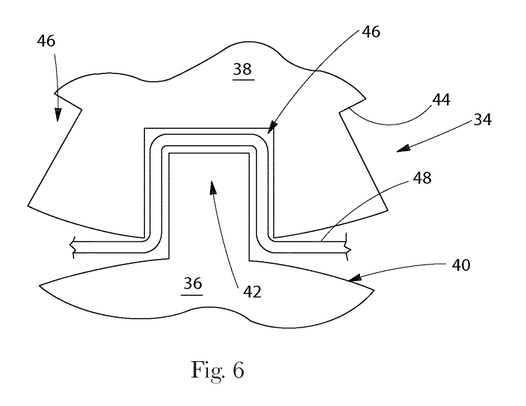

As shown in FIG. 6, an embossing operation according to the present invention comprises an embossing nip 34 comprising a first patterned roll 36 and a second patterned roll 38. The rolls 36 and 38 may comprise complementary or substantially complementary patterns. The first patterned roll 36 comprises a surface 40. The surface 40 may comprise one or more protrusions 42. The second patterned roll 38 comprises a surface 44. The surface 44 may comprise one or more recesses 46. At the embossing nip 34, one or more of the protrusions 42 of the surface 40 mesh with one or more of the recesses 46 of the surface 44. A fibrous structure 48 is positioned between one or more of the protrusions 42 of surface 40 and one or more of the recesses 46 of surface 44 at the embossing nip 34 and/or passes through the embossing nip 34 formed by the meshing of the protrusion 42 with the recess 46 during an embossing operation.

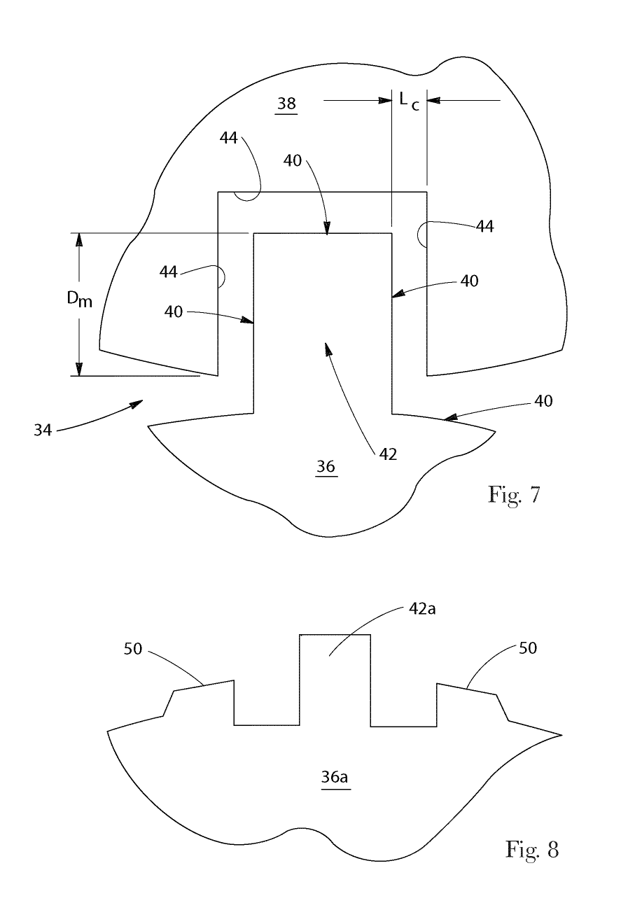

As shown in FIG. 7, which is an enlarged partial view of FIG. 6, the protrusion 42 of surface 40 of the first patterned roll 36 engages (meshes) with the second patterned roll 38 in the recess 46 present on the second patterned roll's surface 44. The meshing of protrusion 42 creates a lateral clearance (L_{C}) and a depth of mesh (D_{M}) in the recess 46.

L_{C} represents the shortest distance between any part of the entire surface 40 of the protrusion 42 of the first patterned roll 36 and any part of the entire surface 44 of the recess 46 of the second patterned roll 38 in the embossing nip 34. L_{C} may be greater than about 75 μm and/or greater than about 100 μm and/or greater than about 125 μm and/or from about 125 μm to about 700 μm and/or to about 600 μm and/or to about 500 μm and/or to about 400 μm and/or to about 300 μm and/or to about 280 μm. In one example, the L_{C} is from about 75 μm to about 700 μm. In one example, the L_{C} of one protrusion to one recess may be different for another protrusion to another recess on the same patterned rolls.

For a given set of patterned rolls, L_{C} may depend upon the fibrous structure being embossed by the patterned rolls. For example, a typical fibrous structure may exhibit a thickness of 254-381 μm (10-15 mils) and the above L_{C} values are suitable for embossing such a fibrous structure having that thickness. However, if a fibrous structure exhibited a thickness of 762 μm (30 mils) or greater, then the L_{C} between the patterned rolls may have to be greater to achieve the optimal embossments in the fibrous structure. Accordingly, the L_{C} may be from about 25% to about 85% and/or from about 30% to about 80% and/or from about 40% to about 80% of the thickness of the fibrous structure being embossed.

D_{M} represents the greatest distance that protrusion 42 overlaps the recess 46 in the embossing nip 34. D_{M} may be greater than about 254 μm (10 mils) and/or greater than about 381 μm (15 mils) and/or greater than about 508 μm (20 mils) and/or to about 2032 μm (80 mils) and/or to about 1524 μm (60 mils) and/or to 1016 μm (40 mils) and/or to about 889 μm (35 mils) and/or to about 762 μm (30 mils) and/or from about 381 μm (15 mils) to about 2032 μm (80 mils) and/or from about 508 μm (20 mils) to about 1524 μm (60 mils) and/or from about 508 μm (20 mils) to about 1016 μm (40 mils). In one example, the D_{M} of one protrusion into one recess may be different for another protrusion into another recess on the same patterned rolls.

In one example, the D_{M} is chosen to create a subtle background image. In another example, the D_{M} is chosen to create a distinct sheet impression.

The nip pressure within the embossing nip 34 when a fibrous structure is present within the embossing nip 34 may be less than about 80 pli and/or less than about 60 pli and/or less than about 40 pli and/or less than about 20 pli and/or less than about 10 pli to about 1 pli and/or to about 2 pli and/or to about 5 pli. In one example, the nip pressure in the embossing nip 34 when a fibrous structure is present within the embossing nip 34 is from about 2 pli to about 10 pli and/or from about 5 pli to about 10 pli.

When a fibrous structure is present within the embossing nip 34, the nip pressure within the embossing nip 34 results in a deformation force (strain) being applied to the fibrous structure, in all directions including and between the machine and cross machine directions, which may result in an embossment being created in the fibrous structure. In one example, the fibrous structure during the embossing operation is subjected to a strain in all directions including and between the machine and cross machine directions such that the fibrous structure experiences a maximum and a minimum strain that differs by less than 25% across all directions.

The strain required to achieve a desired embossment appearance varies with the fibrous structure's properties. For example, a fibrous structure with higher stretch may require more strain to achieve a desired permanent depth of emboss (D_{E}) than a fibrous structure with lower stretch. It has also been found that discrete protrusions (i.e., dot embossing elements) such as dots can more easily be embossed and attain permanent deformation than line protrusions (i.e., line embossing elements). Thus, given a desired pattern and fibrous structure's properties, the L_{C} and D_{M} can be selected to achieve the target strain and corresponding embossment appearance in that portion of the emboss pattern.

### Patterned Rolls

The embossing operation of the present invention utilizes two or more patterned rolls that create a nip pressure, when engaged with one another to form an embossing nip, sufficient to create deformations (embossments) in a fibrous structure present within the embossing nip.

The patterned rolls may comprise complementary patterns. The patterned rolls may be made from the same material or different materials. Nonlimiting examples of suitable materials for the patterned rolls may include steel, ebonite, aluminum, other metals, ceramic, plastics, rubber, synthetic rubber and mixtures thereof.

The patterned rolls may be made by any suitable process known in the art. Non-limiting examples of suitable processes include laser engraving hard plastic (ebonite) or ceramic or other material suitable for laser ablation to remove material and create embossing elements, chemical engraving of steel or other materials to remove material and create embossing elements, machining aluminum or steel or other metals to remove material and create embossing elements, metallizing processes to build up embossing elements, sintering processes to build up embossing elements and/or other means known in the art to remove material or build up material and achieve a surface topography with the desired pattern and clearances between mating embossing elements.

In one example, the patterned rolls are made by laser engraving a pattern onto a surface of a roll, such as an Ebonite roll.

The patterned rolls may comprise protrusions and/or recesses (i.e., dot and/or line embossing elements) in any configuration or pattern and at any frequency desired.

It has been surprisingly discovered that open zones between protrusions on a patterned roll may result in localized fibrous structure strain around the protrusions at the periphery of the open zone to be less than needed for causing deformation (i.e., formation of an embossment) of the fibrous structure as there is ample “untrapped” fibrous structure nearby to flow toward the protrusion when the fibrous structure is present in the embossing nip.

As shown in FIG. 8, a first patterned roll 36a may comprise a strain equalizing element 50 adjoining one or more protrusions 42a. The strain equalizing element 50 is not intended to create an embossment in a fibrous structure when the fibrous structure is present in an embossing nip comprising the first patterned roll 36a and another roll. The strain equalizing element 50 provides a means of restricting fibrous structure flow toward the protrusion present on a patterned roll adjoining relatively large open areas in the emboss pattern present on a patterned roll, thereby ensuring similar strain in the fibrous structure in all areas of the emboss pattern.

In another example, the strain around an element may be controlled by machining a pair of patterned rolls so that a protrusion on a first patterned roll would have a first L_{c} for one side and a second, different L_{C} for another side when the protrusion is engaged with a recess on the other patterned roll.

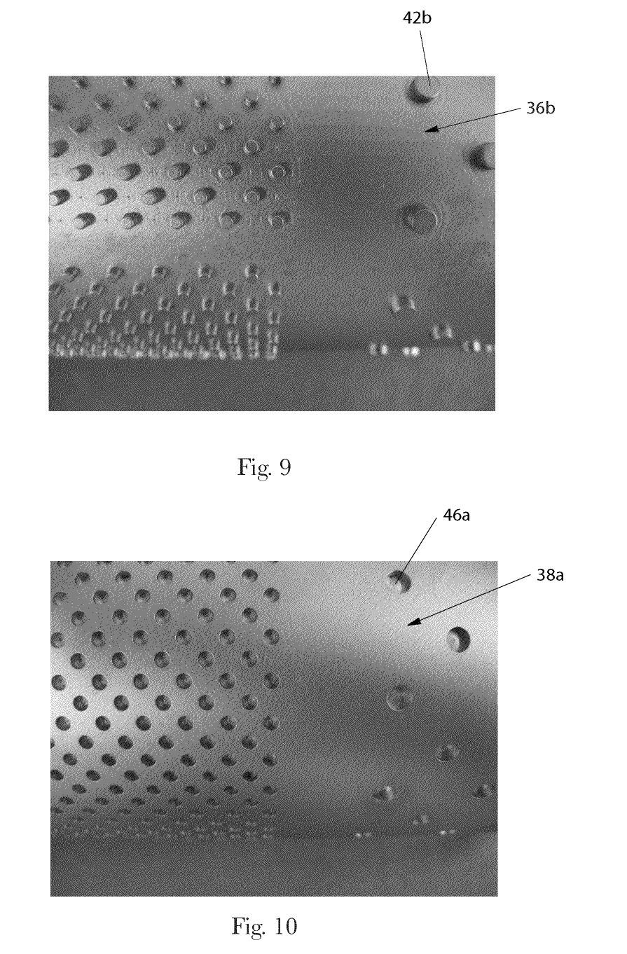

In one example as shown in FIG. 9, a first patterned roll 36b may comprise one or more protrusions 42b (i.e., male protuberances). As shown in FIG. 10, a second patterned roll 38a may comprise one or more recesses 46a (i.e., female recesses). In one example, an embossing nip is formed by engaging the first patterned roll 36b and the second patterned roll 38a such that at least one protrusion 42b of the first patterned roll 36b meshes with at least one recess 46a of the second patterned roll 38a. The protrusions 42b and recesses 46a may be discrete dot and/or line embossing elements as shown in FIGS. 6-9.

At least one of the first and second patterned rolls of the present invention may exhibit an external diameter of less than about 35 cm (14 in.) and/or less than about 25 cm (9.8 in.). In one example, both the first and second patterned rolls exhibit and external diameter of less than about 35 cm (14 in.) and/or less than about 25 cm (9.8 in.).

In one example, at least one of the first and second patterned rolls is capable of creating dot embossments in a fibrous structure. In another example, at least one of the first and second patterned rolls is capable of creating line element embossments in a fibrous structure. In yet another example, at least one of the first and second patterned rolls is capable of creating dot and line element embossments.

### High Density Winding

To achieve the relatively high roll densities of the present invention, the fibrous structure is wound into a roll using a winder and process as disclosed in co-pending U.S. Ser. No. 11/267,736, (US Publ. No. 2007/0102559 A1), entitled Rewind System, filed Nov. 4, 2005, which is hereby incorporated herein by reference. The process and apparatus, referred to herein as “hybrid winding” is also disclosed in commonly-owned U.S. Pat. Nos. 7,392,961 and 7,455,260, each of which are hereby incorporated herein by reference. In the prior art, a winder or reel is typically known as a device that performs the very first wind of that web material, generally forming what is known as a parent roll. A rewinder, on the other hand, is generally known as a device that winds the web material from the parent roll into a roll that is essentially the finished product. For purposes of the present application, the words “winder” and “rewinder” are interchangeable with one another in assessing the scope of the claims.

The terms machine direction, cross-machine direction, and Z-direction are generally relative to the direction of web material 112 travel. The machine direction is known to those of skill in the art as the direction of travel of web material 112. The cross-machine direction is orthogonal and coplanar thereto. The Z-direction is orthogonal to both the machine and cross-machine direction.

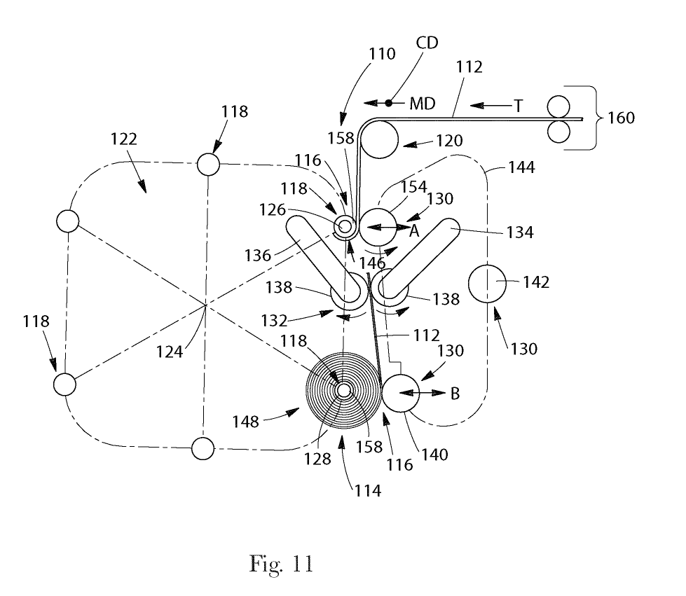

Referring now to the drawings, FIG. 11 shows a cross-sectional view of an exemplary winder 110 in accordance with the present invention. The winder 110 is suitable for use in winding a web material 112 to produce a finally wound product 114. The finally wound product 114 that may be produced by the winder 110 of the present invention can be any number of types of products such as hand towels, toilet tissue, paper towels, polymeric films, trash bags, and the like. As such, web material 112 can comprise continuous web materials, discontinuous web materials comprising interleaved web segments, combinations thereof, and the like. Exemplary materials suitable for web material 112 of the present invention include, without limitation, metal foils, such as aluminum foil, wax paper or grease-proof paper, polymeric films, non-woven webs, fabrics, paper, combinations thereof, and the like. The web material 112 is shown as being transported by the winder 110 in the direction indicated by the arrow T. The winder 110 transports the web material 112 into contacting engagement with at least a first set of cooperative rollers 116. Cooperative rollers 116 generally comprise a first winding spindle 118 and a roll 130 also disclosed herein as a surface contact roll 130.

The web material 112 can be transported and/or assisted by an exemplary web delivery system 120 into winding contact with at least one winding spindle 118. In a preferred embodiment, a plurality of winding spindles 118 are disposed upon a winding turret 122 indexable about a center shaft thereby defining winding turret axis 24. The winding turret 122 may be indexable, or moveable, about winding turret axis 24 through an endless series of indexed positions. For example, a first winding spindle 126 can be located in what may conveniently be called an initial transfer position and a second winding spindle 128 can be located in what may conveniently be called a final wind position. In any regard, the winding turret 122 is indexable about winding turret axis 24 from a first index position to a second index position. Thus, the first winding spindle 126 is moved from the initial transfer position into the final wind position. Such indexable movement of the first winding spindle 126 disposed upon winding turret 122 about winding turret axis 24 may comprise a plurality of discrete, defined positions or a continuous, non-discrete sequence of positions. However, it should be appreciated that winding spindle 118 can be brought into proximate contact with a roll 130 by any means known to one of skill in the art. Exemplary, but non-limiting, turrets suitable for use with the present invention (including “continuous motion” turrets) are disclosed in U.S. Pat. Nos. 5,660,350; 5,667,162; 5,690,297; 5,732,901; 5,810,282; 5,899,404; 5,913,490; 6,142,407; and 6,354,530. As will also be appreciated by one of skill in the art, the so-called ‘open-loop’ turret systems would also be suitable for use as a support for the disposition and movement of winding spindles 118 used in accordance with the present invention. An exemplary, but non-limiting, ‘open-loop’ turret system is disclosed in International Publication No. WO 03/074398.

If so desired by the practitioner, the roll 130 of the present invention may be provided with a relieved surface. In such an embodiment, the relieved portions can be provided as a pattern disposed upon, or within, the material comprising roll 130. Such a pattern may be disposed upon, or otherwise associated with roll 130 by laser engraving, mechanical implantation, polymeric curing, or the like. In an exemplary, but non-limiting embodiment, such a pattern, relieved or otherwise, may correspond to any indicia, embossments, topography pattern, adhesive, combinations thereof, and the like, that are disposed upon, or disposed within, web material 112. It is believe that such an exemplary pattern associated with a roll 130 may be registered with respect to any direction, or directions, of web material 112, particularly the machine- and/or the cross-machine directions of web material 112. Such a pattern can be associated with a roll 130 and can be provided relative to any indicia, embossments, topography pattern, combinations thereof, or the like, associated with web material 112 by any means known to one of skill in the art. Such an embodiment may be useful in preserving desirable features in the web material 112 such as embossments, or may provide a desired contact force, such as for improved bonding force in discrete and/or desired areas of a two-ply, or other multiple-ply, product comprising adhesive for joining one ply to another. Similarly, the roll 130 can be provided with embossments and/or any other type of topographical pattern corresponding to the portions of a multi-ply type of web material 112 that may have an adhesive or other bonding formulation or structure disposed between the plies forming such a web material 112 structure. A roll 130 provided with such embossments and/or any other type of topographical pattern disposed thereon can provide for better adhesion and/or bonding of the plies forming a multi-ply web material 112 by providing additional pressure to the region sought to be so bonded as would be known to one of skill in the art. Without desiring to be bound by theory, it is believed that such increased bonding can be useful for the prevention of so-called “skinned” rolls wherein the plies of a multiple-ply finally rolled product 114 separate during dispensing by the consumer. This is known to those of skill in the art as an undesirable quality defect.

In a preferred embodiment of the present invention, the roll 130 is driven at a surface speed that corresponds to the speed of the incoming web material 112. A positioning device (not shown), such as linear actuators, servo motors, cams, links, and the like, known by those of skill in the art as useful for such a result, can be provided for control of the position of the longitudinal axis of roll 130 relative to the longitudinal axis of a winding spindle 118. Such a positioning device (not shown) associated with a roll 130 may be capable of moving the roll 130 in any direction, including, but not limited to, the machine direction, the cross-machine direction, the Z-direction, and/or any combination thereof. In a preferred embodiment, the movement of a roll 130 is generally parallel to the Z-direction relative to web material 112 as web material 112 passes proximate to, or in contacting engagement with, a winding spindle 118. It is believed that in this way, the position of the roll 130, when combined with the known diameter growth of the log associated with second winding spindle 128, can provide the required contact, clearance, and/or pressure between the roll 130 and the log associated with second winding spindle 128 having web material 112 being disposed thereon. However, it should be realized that the roll 130 can be provided with movement with respect to any direction relative to its longitudinal axis in virtually any direction required to provide the required contact or clearance between the roll 130 and the log associated with second winding spindle 128. Likewise, the roll 130 can have virtually any number of axes (i.e., at least one) associated thereto as required in order to provide the required contact or clearance between the roll 130 and the log associated with second winding spindle 128 as web material 112 passes therebetween.

If contact between the roll 130 through web material 112 to the log associated with second winding spindle 128 is desired, the position of a respective roll 130 along an exemplary axis A and/or B, can be controlled to a known position in order to provide the desired contact, or clearance, between the respective roll 130 and the respective log associated with the first or second winding spindle 126, 28 throughout the entire wind, if required. Maintaining desired contact, or clearance, throughout the entire wind may be particularly advantageous when winding products having higher densities. Maintaining contact throughout the wind, in such an instance is believed to facilitate compaction of all layers of web material 112 within the finally wound product 114, thereby providing maximum potential density. Maintaining contact throughout the entire wind is also believed to provide product consistency when the web material 112 comprises a structure that is affected by contact force against the roll 130. By way of example, embossed areas disposed upon web material 112 may have a different appearance or thickness in a region contacted by the roll 130 compared to an area of roll 130 not so contacted.

Alternatively, the position of roll 130 can be positioned along axis A and/or B respectively in order to regulate the contact force between the roll 130 and the respective log associated with first or second winding spindle 126, 28. By way of example, in order to provide a low density product roll design upon finally wound product 114, there may be minimal or even no contact between the respective roll 130 and the log associated with second winding spindle 128. For medium density product roll designs in finally wound product 114, there may be moderate contact, or force, between the respective roll 130 and the log associated with second winding spindle 128. For providing high density product roll designs in finally wound product 114, there may be relatively high contact, or force, between the respective roll 130 and the log associated with second winding spindle 128. In any regard, it is preferred that the rotational speed of the winding spindles 118 be controlled in order to decelerate at a rate that maintains the same winding surface speed, or desired speed differential, as the diameter of the log associated with second winding spindle 128 increases.

Alternatively, the product density of a finally wound product 114 can be adjusted by adjusting the surface speed of the roll 130 and/or the surface speed of the respective log associated with first or second winding spindle 126, 28. Without desiring to be bound by theory, it is believed that providing such a speed differential between the surface speed of the roll 130 and/or the surface speed of the respective log associated with first or second winding spindle 126, 28 can vary the tension present in the web material 112 forming finally wound product 114. By way of non-limiting example, in order to provide a low density finally wound product 114, there may be minimal, or even no, speed differential between the surface speed of the roll 130 and/or the surface speed of the log associated with second winding spindle 128. However, if a high-density finally wound product 114 is desired, there may be relatively high speed differential, or bias, between the surface speed of the roll 130 and/or the surface speed of the log associated with second winding spindle 128. In any regard, the surface speeds of the roll 130 and/or the log associated with second winding spindle 128 can be controlled jointly, or severally, in order to provide a finally wound product 114 having the desired wind profile.

As shown in FIG. 11, the winder 110 may provide a turret 122 supporting a plurality of winding spindles 118. The winding spindles 118 may engage a core (not shown) upon which the web material 112 is wound. The winding spindles 118 may be driven in a closed spindle path about the winding turret 122 assembly central axis 24. Each winding spindle 118 extends along a winding spindle 118 axis generally parallel to the winding turret 122 assembly winding turret axis 24, from a first winding spindle 118 end to a second winding spindle 118 end. The winding spindles 118 may be supported at their first ends by the winding turret 122 assembly. The winding spindles 118 may be releasably supported at their second ends by a mandrel cupping assembly (not shown). The winding turret 122 may support at least two winding spindles 118, for example at least six winding spindles 118, and in one embodiment, the turret assembly 122 supports at least ten winding spindles 118. As would be known to one of skill in the art, a winding turret assembly 122 supporting at least 10 winding spindles 118 can have a rotatably driven winding turret 122 assembly which is rotated at a relatively low, and for example generally constant, angular velocity to reduce vibration and inertial loads, while providing increased throughput relative to indexing a winding turret 122 which is intermittently rotated at higher angular velocities. Exemplary winding turret assemblies suitable for use with the present invention are disclosed in U.S. Pat. Nos. 5,690,297 and 5,913,490.

A perforator roll, anvil, or any other non-contact perforation device known by those of skill in the art (not shown) can be adapted to provide lines of perforations extending along the cross-machine direction of the web material 112. Adjacent lines of perforations may be spaced apart at a pre-determined distance along the length of the web material 112 to provide individual sheets of web material 112 that are joined together at the perforations. The sheet length of the individual sheets of web material 112 is the distance between adjacent lines of perforations.

Once the desired number of sheets of web material 112 have been wound onto a log associated with second winding spindle 128, in accordance with the present invention, a web separator 132 can be moved into a position proximate to web material 112 disposed between successive cooperative rollers 116 (i.e., successive rolls 30 and successive winding spindles 118) in order to provide separation of adjacent sheets of perforated web material 112. The web separator 132 can be provided as a rotary unit shearing apparatus known to those of skill in the art useful for the severance of the web material 112 into individual sheets. In a preferred embodiment, the web separator 132 is provided as a pair of articulating elements 134, 136 that cooperatively engage web material 112 in a position intermediate successive cooperative rollers 116 (i.e., a first roll 130 and a first winding spindle 126 and a second roll 130 and second winding spindle 128). In such a preferred embodiment, the web separator 132 intermittently and/or periodically contactingly engages the web material 112 disposed between successive cooperating rollers 116. Alternatively, a suitable web separator 132 for the present invention can be provided as a plurality of semi-continuous speed rolls (not shown) that are constantly in contact with the web material 112 disposed between successive cooperating rollers 116. The elements comprising such a semi-continuous web separator 132, either individually or collectively, can be provided with momentary periods of acceleration or deceleration. Yet still, the web separator 132 can be provided with a plurality of contacting arms provided with surfaces 138 such as a smooth rubber surfaces and/or pressers, or pads, intended to exert a pressure, through a slight interference, against an opposing surface 138 such as a smooth rubber surface and/or pressers, or pads. In such an embodiment, each element, such as exemplary articulating arms 134, 136, of the web separator 132 may rotate intermittently, in a clockwise or counterclockwise direction respectively. However, in any regard, each element 134, 136 of the web separator 132 may be provided with a pendulum-like oscillatory movement. As such, the surfaces 138 comprising pressers or pads disposed upon each element 134, 136 of web separator 132 may move along a circular path which has an axis coincident with the axis of rotation of each element of the web separator 132 and almost tangent to (or making a slight interference with) the surface of the opposing element of web separator 132 comprising winder 110.

Once the desired number of sheets of web material 112 have been wound onto the log associated with second winding spindle 128, the web separator 132 is moved (i.e., may be pivoted) into a position which facilitates the formation of a nip between the opposing elements 134, 136 associated with the web separator 132. Such a nip may comprise the surfaces 138 such as rollers, pressers, or pads, cooperatively associated with the elements 134, 136 associated with web separator 132. The movement of the elements 134, 136 comprising web separator 132 may be timed so that the web separator 132 nips the web material 112 between opposing elements 134, 136 of web separator 132 when the perforation at the trailing end of the last desired sheet for the log associated with second winding spindle 128 is located between the cooperative rollers 116 comprising the first, or new, winding spindle 126 and a first surface contact roll 130 at the transfer position (i.e., at the web material 112 nip point) and the contact point of the elements 134, 136 comprising web separator 132.

Additionally, the portions of the elements 134, 136 of web separator 132 that form the nip against the web material 112 can be provided with surface speeds that are either less then, the same as, or greater than, the surface speed of the web material 112 cooperatively associated thereto. In a preferred embodiment, at least one element 134, 136, or the surfaces 138 thereof, forming the web separator 132 is provided with a surface speed greater than that of the surface speed of the web material 112 cooperatively associated thereto. Without desiring to be bound by theory, it is believed that if one element 134, 136, or the surfaces 138 thereof, comprising web separator 132 is provided with a low coefficient of friction and the corresponding element 134, 136, or the surfaces 138 thereof, of web separator 132 is provided with a surface speed greater than that of web material 112, the web separator 132 effectively accelerates the web material 112 at the nip point because the web material 112 slips relative to one element 134, 136, or the surfaces 138 thereof, comprising web separator 132 traveling at the desired web material 112 winding speed. Concurrent with such over-speed nip formation between corresponding elements 134 comprising web separator 132, a succeeding new winding spindle 118 that will form the log associated with first winding spindle 126, traveling at the same surface speed as the web material 112, nips the web material 112 against a roll 130 thereby forming cooperative rollers 116. Such a combination of the downstream over-speed nip formation between engaging elements 134, 136 comprising web separator 132 and the winding speed upstream nip formation between cooperative rollers 116 causes the perforation disposed upon web material 112 located between the two nip points to break resulting in the formation of a finally wound product 114 having the desired number of sheets of web material 112 disposed thereon resulting from the log associated with second winding spindle 128.

Alternatively, one of elements 134, 136 comprising web separator 132 can be provided with a surface speed lower than that of the surface speed of the web material 112 cooperatively associated thereto. If one of the elements 134 comprising web separator 132 is provided with a low coefficient of friction and the corresponding second element 136 comprising web separator 132 is provided with a surface speed lower than that of the first element 134 comprising web separator 132, the second element 136 comprising web separator 132 can decelerate the web material 112 at the nip point. This is because the web material 112 slips relative to the first element 134 comprising web separator 132 causing the perforation disposed between the elements 134, 136 comprising web separator 132 and cooperative rollers 116 (i.e., second winding spindle 128/roll 130) nip points to break resulting in the formation of a finally wound product 114 having the desired number of sheets of web material 112 disposed thereon resulting from the log associated with second winding spindle 128. Concurrent with such an under-speed nip formation between the elements 134, 136 comprising web separator 132, a succeeding new winding spindle 118 that will form the log associated with first winding spindle 126, traveling at the same surface speed as the web material 112, nips the web material 112 against the respective roll 130 corresponding and cooperatively associated thereto. That portion of web material 112 disposed beyond the nip formed between first winding spindle 126 and the roll 130 cooperatively associated thereto can then be recalled and wound upon first winding spindle 126.

In yet still another embodiment, the elements 134, 136 comprising web separator 132 can be surface-speed matched with web material 112. In such an embodiment, one element 134 comprising web separator 132 may be provided with at least one blade that is inter-digitating and/or nestably related with a corresponding depression, groove, and/or blade, retractable or otherwise, disposed upon second element 136 comprising web separator 132. It is believed that such inter-digitating and/or nestable blade assemblies known by those of skill in the art can be adapted to provide such a surface speed-matched web separator 132 assembly. By way of non-limiting example, the assemblies discussed in U.S. Pat. Nos. 4,919,351 and 5,335,869 can be adapted to provide such a surface speed-matched web separator 132 assembly suitable for use with the present invention.

The web material 112 upstream of the nip formed between the elements 134, 136 comprising web separator 132 is then transferred to a new winding spindle 118 which has had an adhesive disposed thereon to form first winding spindle 126. In a preferred embodiment, a core is disposed upon the new winding spindle 118 that forms first winding spindle 126 and is held securely thereto. The winding turret 122 comprising the winding spindles 118 moves the first winding spindle 126 to the finish wind position, either intermittently or continuously, and the winding cycle is repeated. After the wind has been completed, the finally wound product 114 is removed from first winding spindle 126 disposed upon turret assembly 122 and a new core may be disposed upon the now vacant winding spindle 118. Adhesive can then be applied to the new core prior to the web transfer. The winding sequence is then repeated as required.

As described previously, a preferred embodiment of the present invention includes winding the web material 112 on hollow cores for easier roll mounting and dispensing by the consumer. Additionally, the winder 110 of the instant invention provides for adjustable sheet length capability in order to provide format flexibility and sheet count control in increments of one for such format flexibility.

Further, one of skill in the art could provide the winding spindles 118 with a speed profile that can allow for enhanced winding capability of winder 110. Such enhanced winding capability may be useful or even preferable with low-density substrates. Additionally, disposing web material 112 between the first winding spindle 126 and a corresponding and engaging roll 130 forming cooperative rollers 116 can provide for an adjustable contact position and/or force upon winding spindle 118 and the web material 112 at the periphery of the log associated with second winding spindle 128. Providing second winding spindle 128 with an adjustable rotational speed can provide for the ability to apply a force at the point where web material 112 is disposed upon second winding spindle 128. This process can provide for a finally wound product 114 having the desired wind profile.

For example, finally wound product 114 may be produced as a web material 112 having a perforated sheet length of 250 mm, a 100 sheet count, a finished roll diameter of 130 mm, and be wound upon a core having an outer diameter of 40 mm Using this information, the theoretical average radial thickness for each layer of web material 112 comprising finally wound product 114 can be calculated to be about 480 μm. In such an exemplary embodiment, the web material 112 may be provided with an initial (i.e., untensioned) thickness of 750 μm as web material 112 enters the winding area of winder 110. In order to provide for the above-described finally wound product 114, if no contact exists between the log associated with a winding spindle 118 and the corresponding surface contact roll 130, the web material 112 must be compressed from the initial thickness of 750 μm to the required theoretical target thickness of 480 μm by only the tension exerted by the winding spindle 118 speed on the incoming web material 112. Without desiring to be bound by theory, the calculated tension required to decrease the thickness of web material 112 from an initial 750 μm thickness to the required 480 μm thickness is about 500 grams per linear cm. However, one of skill in the art will appreciate that the web material 112 may separate uncontrollably at the perforations disposed within web material 112 when web material 112 is subject to such a tension (i.e., nominally greater than 350 grams per linear cm). Such uncontrolled separations can produce an unacceptable finally wound product 114 and potentially result in line/production stoppages.

Additionally, the winder 110, as disclosed supra, may be utilized to provide supplemental compression of the web material 112 being wound upon a winding spindle 118 to produce finally wound product 114. For example, a roll 130 may be loaded against the log associated with the corresponding winding spindle 118 by moving the position of the roll 130 relative to a winding spindle 118 in order to achieve the desired finally wound product 114. For example, a roll 130 may be loaded against a log disposed upon a corresponding winding spindle 118 with a force of 100 grams per linear cm. By calculation, it is believed that such a force may decrease the thickness of the web material 112 from a thickness of 750 μm to a thickness of 500 μm. The calculated required winding tension to further decrease the thickness of web material 112 from a thickness of 500 μm to the required thickness of 480 μm may be provided with as little as 40 grams per linear cm. This required tension level is well below the known, and assumed, perforation separation level of 350 grams per linear cm, thereby allowing reliable production of the desired finally wound product 114.

Additionally, one of skill in the art will understand that the winder 110 disclosed herein can provide contact with the log associated with second winding spindle 128 throughout the entirety of the wind cycle. Thus, a finally wound product 114 can be provided with heretofore unrealized wind uniformity throughout the entire finally wound product 114. Further, one of skill in the art will realize that providing winding spindles 118 in a turret system 122 moving in a closed path can provide for continuous winding and removal of finally wound product 114 without the need to interrupt the turret system 122 to load and unload winding spindles 118 or even the cores disposed upon winding spindles 118 from a moving turret system 122 mechanism.

Ply Bonding and/or Fluid Treatment

Fibrous structures of the present invention can be multi-ply, and can be ply bonded by known means, including by the method disclosed in U.S. Ser. No. 12/185,477 (US Publ. No. 2010/0030174 A1), entitled Multi-ply Fibrous Structures and processes for Making Same, filed Aug. 4, 2008, which is hereby incorporated by reference herein. The method and process disclosed in U.S. Ser. No. 12/185,477 can also be used to deposit functional fluids onto a fibrous structure, such as wet strength additives, fiber softeners, lotions, and the like.

The fibrous structure of the present invention can have added thereto by means known in the art, including by spraying with a hand-held sprayer, a web treatment to improve the structure resiliency properties of the fibrous structure. The fluids may be applied to a moving sheet during the converting operation (i.e., after drying and before embossing or other post-paper-making converting) at a desired add-on rate by means known in the art such as spray, slot die, gravure, roto-spray, offset gravure, permeable rolls, and the like. The fluids may be applied in a uniform manner over the entirety of the substrate or in discrete zones which may be registered (in both the machine direction and cross machine direction) to other product features such as embossing, printing, other fluid applications for performance improvement such as softness, perforation, folding, cutting, and the like.

Fluids for web treatment can comprise steam, silicone, polyquats, other fluids useful for modifying the properties of the sheet structure, and any combinations thereof. In general, for a fibrous structure of the present invention, a fibrous web can be treated prior to the embossing step.

By treating a fibrous web prior to embossing, ply-bonding, or winding, the subsequent fluid-treated fibrous web exhibits improved fibrous structure formation and resiliency after being subjected to compressive forces. It is believed that application of fluid chemistry and/or polymers to a fibrous web creates a structure resiliency that allows embossed paper to be compressed by z-direction forces associated with a winding process, and then spring back to the original state or near-original state when dispensed from a rolled form. The original state or near-original state includes properties such as thickness, absorptive capacity, absorptive rate, and emboss depth and clarity.

In an embodiment, the fluid is polyquat, such as PQ6. In one embodiment the fluid is applied by hand-held sprayer.

### Fibrous Structure

The fibrous structure of the present invention may be made by an embossing operation as disclosed above, and wound into a roll by the winding process disclosed above. In an embodiment, the fibrous structure can be treated with a fluid treatment, as described above.

The fibrous structure made by an embossing operation of the present invention that utilizes one or more patterned rolls comprises one or more embossments. In one example, the fibrous structure of the present invention comprises a plurality of embossments. The embossments may comprise discrete dot and/or line element embossments. In one example, the fibrous structure of the present invention comprises a line element embossment at least partially surrounded, such as on at least two sides of the line element embossment, by a line of a plurality of dot embossments. The dot embossments in the fibrous structure of the present invention may be any desired shape, for example circles, ellipses, squares, triangles. The line element embossments may be of any width, length, radius of curvature.

One or more of the embossed fibrous structures of the present invention may be utilized as a single-ply or multi-ply sanitary tissue product. In one example, one or more the embossed fibrous structures of the present invention are combined with one or more other fibrous structures, the same or different, to form a multi-ply fibrous structure. The multi-ply fibrous structure may be utilized as a multi-ply sanitary tissue product.

### Process for Making Multi-Ply Fibrous Structure

One or more embossed fibrous structures of the present invention may be combined with another fibrous structure, either the same or different, to form a multi-ply fibrous structure.

In one example, a process for making a multi-ply fibrous structure comprises the step of combining a fibrous structure embossed by the method described herein with another fibrous structure to form a multi-ply fibrous structure.

In one example, the process includes fluid treatment of a fibrous web prior to embossing and/or winding into a fibrous structure of the present invention.

In another example, a process for making a multi-ply fibrous structure comprises the steps of:
a. providing a first fibrous web that can be a TAD paper web made by known processes;
b. optionally fluid treating the fibrous web at an add-on level to impart sufficient compression resiliency, which fluid treatment can be by known processes;
c. embossing the fibrous web to create a fibrous structure, which embossing can be by close tolerance embossing as described herein;
d. providing a second fibrous web, which can be a TAD paper web made by known processes;
e. bonding the first fibrous structure to the second fibrous web to form in a multi-ply fibrous structure, which bonding can be by known processes.
   The second fibrous web may be an embossed fibrous structure. In one example, the second fibrous structure may be an embossed fibrous structure like the first fibrous structure.

The first and second fibrous structures may comprise the same emboss pattern or they may be different.

The bonding step may comprise applying an adhesive to at least one of the fibrous structures. The adhesive may be applied to one or more surfaces of the fibrous structure by any suitable process known to those skilled in the art. Non-limiting examples of suitable processes include smooth applicator roll process, patterned applicator roll, gravure roll application process, slot extrusion, spray process, permeable fluid applicator process and combinations thereof. The adhesive may cover 100% of the surface area of the fibrous structure or some portion of the surface area of the fibrous structure. The less adhesive coverage the less negative impact to softness of the multi-ply fibrous structure. A non-limiting example of a suitable adhesive for use in the processes of the present invention includes polyvinyl alcohol. In one example, the adhesive is a polyvinyl alcohol that has a viscosity at 14% solids of 10,000 centipoise.

After adhesive is applied to one or more of the fibrous structure plies, the plies are brought into proximity. If a fibrous structure other than the embossed fibrous structure of the present invention is embossed, its emboss pattern is typically complementary to the emboss pattern on the embossed fibrous structure ply of the present invention and is brought into proximity in a registered manner. For example, one fibrous structure ply may have embossments that provide permanently deformed zones that extend upward in the z-direction. When these embossments are registered with embossments of an embossed fibrous structure ply of the present invention, the embossed z-direction embossments in the other ply may provide support for unembossed zones in the embossed fibrous structure ply of the present invention, thus providing a consumer preferred undulating topography that is perceived as soft and pillowy. After the plies are brought into proximity (in a registered manner if desired), the resulting multi-ply fibrous structure is passed through a marrying roll nip.

In one example, the embossing and laminating equipment suitable for use in the present invention may be combined into a modular unit such that the modular unit is capable of being inserted into a papermaking machine at a desired location, such as in the converting section of the papermaking machine.

The embossing operation of the present invention and/or laminating process of the present invention may operate at any suitable speed within a papermaking machine such as greater than about 500 feet per minute (fpm) and/or greater than about 1000 fpm and/or greater than about 1500 fpm and/or greater than about 1800 fpm and/or greater than about 2000 fpm and/or greater than about 2400 fpm and/or greater than about 2500 fpm.

After embossing and laminating, the multi-ply fibrous structure can be conveyed to other fibrous structure processing stations such as lotioning, coating, printing, slitting, folding, perforating, winding, tuft-generating, and the like. Alternatively, some of these other fibrous structure processing transformations may occur prior to the embossing and laminating transformations.

In an embodiment, embossments can cover an area of from about 3% to about 20% of the fibrous substrate. Embossments can cover an area of from about 6% to about 12% and from about 7% to about 9%.

In an example, a process for making a roll of fibrous structure comprises the steps of making a multi-ply fibrous structure as described above, and winding the multi-ply fibrous structure onto a roll by the hybrid winding method described above. The winding can be carried out at relatively low web tension. In one embodiment an embossed substrate of relatively low density TAD fibrous structure was wound while maintaining machine direction tension at less than 4 grams of tension per 1 mm of sheet width.

Fibrous structures of the present invention were formed into rolls of the present invention by means of the winding apparatus and process described above, including at a machine direction tension of less than about 4 grams of tension per 1 mm of sheet width. The winding process was a hybrid winding process, which includes “center winding” capability, in which the spindle is driven, with “surface assisted” winding in which the surface of the roll is driven and compressed. The process can be referred to as “hybrid winding” because it combines both center wind and surface wind processes. The compressive force applied by the surface wind apparatus is applied primarily at the point where the incoming fibrous web meets the winding “log”. This contact point is maintained throughout the entirety of the winding cycle, i.e., from initial transfer of the fibrous structure to the core (e.g., cardboard core) to the point where the full length of fibrous structure has been wound into a finished roll of fibrous structure. The tangential contact of compressive force has been found to be surprisingly effective at achieving the relatively high roll density of TAD and/or embossed fibrous webs, while maintaining consumer preferred sheet properties of dispensed product.

The winding of the rolls of fibrous structure of the present invention is different than other known winding processes such as slitter-rewinder processes and equipment which rewind parent rolls and do not wind finished product logs and/or rolls. In one example, the winding process of the present invention utilizes the winding process described in U.S. Pat. No. 7,000,864 issued Feb. 21, 2006 to McNeil et al, which is hereby incorporated by reference.

The winding process described therein is different from other known winding processes, in particular the slitter-rewinder process. For example, unlike slitter-rewinders, the winding process and equipment described in U.S. Pat. No. 7,000,864 wind the rolls of fibrous structure with RPM changes of at least 400 RPM between 2 and 35 machine degrees (one complete winding cycle is defined as 360 machine degrees).

Wound rolls of fibrous structure, such as paper towels for kitchen use, are typically wound on a cardboard core support, and typically have a roll diameter limit of about 150-175 mm (about 6-6.9 inches). The limits are based primarily on prior art manufacturing limitations on winding uniformity, operating speeds, core loading, log discharging, core clue applications systems, and the like. Improvements of the present invention, including developments in fibrous web “chop off” and fibrous web transfer technology, winding control, as well as surface winding controls, have facilitated the capability to wind fibrous structures into a roll having up to 200 mm (7.8 inches) or greater. For example, the winding as disclosed herein permits more clearance between bed roll and turret, as they are known in the art. The belt of a surface winding element removes a fixed clearance limit, permitting larger rolls. Additionally, the turret was modified from having eight mandrels to six, to accommodate larger diameter finished rolls, and to permit space for the chopper roll, again, as these elements are known in the art. Modifications were made to appropriately increase the speed of indexing from mandrel to mandrel in order to not slow down overall throughput.

Producing relatively high diameter rolls of fibrous structure can be achieved by a process of low stress web transport. Low stress web transport can be important for TAD paper, and/or embossed fibrous webs having relatively low strength and having relatively low density. Low stress web transport can facilitate transporting the fibrous web through the sheet transformation processes in a manner that minimizes substrate stress in the machine direction, cross machine direction, and in the z-direction. One element in such a transport system is maintaining the substrate machine direction tension at a target level that is well below the elastic limit of the material. Exceeding the elastic limit can cause permanent deformation of the material and can compromise performance capabilities (e.g. absorbency rate and capacity, dry and wet strength, softness, thickness, etc.) as well as product aesthetics (e.g. puckered emboss appearance, wrinkles, reduced emboss depth, etc.). It has been found that transporting an embossed substrate, especially a relatively low density TAD embossed substrate, while maintaining machine direction tension at less than 4 grams of tension per 1 mm of sheet width is particularly effective at preserving consumer preferred properties.

In a one embodiment, the tension control and related web handling control systems can be those described in commonly-assigned U.S. Pat. Nos. 6,845,282; 6,991,144; 6,993,964; 7,035,706; and 7,092,781, each of which are hereby incorporated herein by reference. Other web transport practices that have helped include minimizing contact between the substrate and stationary devices (static elimination metal bars, slot die extrusion heads, etc.) and minimizing contact between the substrate and rotating process rolls, especially those that are not independently driven at web speed.

Rolls of embossed fibrous structure were made according to the description herein utilizing close tolerance embossing and hybrid winding to produce rolls of fibrous structure of the present invention. Certain parameters of rolls of fibrous structure of the prior art are presented in Table 6 below, and certain parameters of the present invention are presented in Table 7 below.

TABLE 6
Data on Certain Parameters of Prior Art Rolls of Fibrous Structures.

| | | Sample Number | | | | |
|---|---|---|---|---|---|---|
| Parameter | Units | 1 | 2 | 3 | 4 | 5 |
| Basis weight | [lbs/3000 ft²] | 28 | 28 | 28 | 28 | 28 |
| Dispensed Caliper | [in] | 0.0337 | 0.0316 | 0.031 | 0.0269 | 0.026 |
| Sheet Length | [in] | 10.4 | 10.4 | 6 | 10.4 | 10.4 |
| Sheet Width | [in] | 11 | 11 | 11 | 11 | 11 |
| Sheet Count | [#sheets] | 52 | 70 | 126 | 87 | 130 |
| Roll Diameter | [in] | 4.9 | 5.45 | 5.65 | 5.8 | 6.5 |
| Core Diameter | [in] | 1.7 | 1.7 | 1.7 | 1.7 | 1.7 |
| Sheet Area | [in²] | 114.4 | 114.4 | 66 | 114.4 | 114.4 |
| Sheet Area | [cm²] | 738.1 | 738.1 | 425.8 | 738.1 | 738.1 |
| Web length per roll | [in] | 541 | 728 | 756 | 905 | 1,352 |
| Effective caliper | [in] | 0.0307 | 0.0289 | 0.0302 | 0.0267 | 0.0229 |
| Dispensed Cal/Eff | none | 1.10 | 1.09 | 1.03 | 1.01 | 1.14 |
| Cal | | | | | | |
| Disp Cal/Basis wt * | none | 1.20 | 1.13 | 1.11 | 0.96 | 0.93 |
| 1000 | | | | | | |
| Web Length/Roll | none | 110 | 134 | 134 | 156 | 208 |
| Dia | | | | | | |
| Web area per roll | [in²] | 5,949 | 8,008 | 8,316 | 9,953 | 14,872 |
| Web area per roll | [ft²] | 41.31 | 55.61 | 57.75 | 69.12 | 103.28 |
| Roll weight | [g] | 0.39 | 0.52 | 0.54 | 0.65 | 0.96 |
| excluding core | | | | | | |
| Roll volume | [in³] | 182.46 | 231.64 | 250.82 | 265.66 | 340.05 |
| excluding core | | | | | | |
| Roll density | [lbs/in³] | 0.00211 | 0.00224 | 0.00215 | 0.00243 | 0.00283 |
| Roll density | [g/in³] | 0.96 | 1.02 | 0.97 | 1.10 | 1.29 |
| Roll density | [g/cm³] | 0.058 | 0.062 | 0.059 | 0.067 | 0.078 |

TABLE 7
Data on Parameters of Rolls of Fibrous Structures of the Present Invention

| | | Sample No. | | | | | | |
|---|---|---|---|---|---|---|---|---|
| Parameter | Units | 6 | 7 | 8 | 9 | 10 | 11 | 12 |
| Basis weight | [lbs/3000 ft²] | 28 | 28 | 28 | 35.0 | 35.0 | 35.0 | 35.0 |
| Dispensed Caliper | [in] | 0.030 | 0.030 | 0.030 | 0.032 | 0.032 | 0.032 | 0.032 |
| Sheet Length | [in] | 10.48 | 10.48 | 6 | 10.4 | 6 | 10.4 | 6 |
| Sheet Width | [in] | 11 | 11 | 11 | 11.0 | 11.0 | 11.0 | 11.0 |
| Sheet Count | [#sheets] | 154 | 70 | 282 | 180 | 312 | 240 | 416 |
| Roll Diameter | [in] | 6.513 | 4.917 | 6.5 | 7 | 7 | 8 | 8 |
| Core Diameter | [in] | 1.7 | 1.7 | 1.7 | 1.7 | 1.7 | 1.7 | 1.7 |
| Sheet Area | [in²] | 115.28 | 115.28 | 66 | 114.4 | 66 | 114.4 | 66 |
| Sheet Area | [cm²] | 743.7 | 743.7 | 425.8 | 738.1 | 425.8 | 738.1 | 425.8 |
| Web length per roll | [in] | 1,614 | 734 | 1,692 | 1,872 | 1,872 | 2,496 | 2,496 |
| Effective caliper | [in] | 0.0192 | 0.0228 | 0.0183 | 0.0193 | 0.0193 | 0.0192 | 0.0192 |
| Dispensed Cal/ | none | 1.56 | 1.32 | 1.64 | 1.65 | 1.65 | 1.66 | 1.66 |
| Eff Cal | | | | | | | | |
| Disp Cal/Basis wt * | none | 1.07 | 1.07 | 1.07 | 0.91 | 0.91 | 0.91 | 0.91 |
| 1000 | | | | | | | | |
| Web Length/Roll | none | 248 | 149 | 260 | 267 | 267 | 312 | 312 |
| Dia | | | | | | | | |
| Web area per roll | [in²] | 17,753 | 8,070 | 18,612 | 20,592 | 20,592 | 27,456 | 27,456 |
| Web area per roll | [ft²] | 123.29 | 56.04 | 129.25 | 143.00 | 143.00 | 190.67 | 190.67 |
| Roll weight | [g] | 1.15 | 0.52 | 1.21 | 1.67 | 1.67 | 2.22 | 2.22 |
| excluding core | | | | | | | | |
| Roll volume | [in³] | 341.51 | 183.91 | 340.05 | 398.36 | 398.36 | 527.95 | 527.95 |
| excluding core | | | | | | | | |
| Roll density | [lbs/in³] | 0.00337 | 0.00284 | 0.00355 | 0.00419 | 0.00419 | 0.00421 | 0.00421 |
| Roll density | [g/in³] | 1.53 | 1.53 | 1.61 | 1.90 | 1.90 | 1.91 | 1.91 |
| Roll density | [g/cm³] | 0.093 | 0.079 | 0.098 | 0.116 | 0.116 | 0.117 | 0.117 |

Sample 1 is current market Bounty® product, marketed as “Regular Roll”.
Sample 2 is current market Bounty® product, marketed as “Big Roll”.
Sample 3 is current market Bounty® product, marketed as “Giant Roll”.
Sample 4 is current market Bounty® product, marketed as “Mega Roll”.
Sample 5 is current market Bounty® product, marketed as “Huge Roll”.
Sample 6-11 are fibrous substrates identical to that of Samples 1-5, but with the indicated basis weight.

As can be seen in Table 7, rolls of fibrous structure according to the present invention offer advantages over prior art rolls. In particular, the relatively higher roll densities associated with rolls of the present invention permit a manufacturer to provide more product to a consumer without requiring correspondingly more space (volume). The advantages to such a roll of fibrous structure are numerous. For one, a consumer need not purchase product as often; a single roll of fibrous structure of the present invention can provide a consumer with many more sheets of product (for sheeted, perforated product) than a prior art roll having similarly-sized sheets. Also, a consumer can benefit from cost advantages associated with relatively reduced cost per sheet to provide to the consumer rolls of fibrous structure. Additionally, the consumer can benefit from space savings by storing more product per space (volume) in his or her home.

The relatively high roll density of the present invention also benefits manufacturers and their customers, which are generally retail outlets such as Sam's Club, Wal-Mart, Target, and other food and drug outlets. For shippers, weight per shipping volume can be maximized by providing more product per roll, which can yield more product per pallet or more product per truck or rail car. For retailers, shelf space or end of aisle displays can be economized by providing for denser product display. By providing more product display per volume of display space, the retailer's display space is economized. Therefore, the present invention also includes methods of shipping product of rolls of fibrous structure, and methods of offering such product for sale at a retail outlet.

A method of economically transporting fibrous structure can comprise the steps of providing at a loading location, such as the loading dock of a manufacturer of fibrous structure, a pallet having palletized thereon said rolled fibrous structure. The pallet can be any pallet as known in the art, and can be made of wood, fiber composite, or the like. The palletized rolled fibrous structure can be in the form of a plurality of rolls of through-air-dried paper, the paper being in the form of a continuous web, each roll having a roll density of at least about 0.12 grams per cubic centimeter. Additionally, the fibrous structure can comprise other parameters as described herein, including a basis weight less than about 45 or less than about 40 or less than about 35 or less than about 30 pounds per 3000 square feet. The rolls can be packaged into multi-roll packages and can be stacked as is known in the art, and can be shrink wrapped or otherwise stabilized. The palletized load can have a volume defined by a the volume of the smallest cube that can contain all the rolled fibrous structure (but not the pallet or other packaging such as shrink wrap, straps, or the like). The palletized load can have a pallet density equal to the mass of palletized fibrous structure divided by the palletized load volume. The method can further include loading the palletized rolled fibrous structure onto a means of transportation, such as a truck or shipping container, as is known in the art. The method can further include moving the means for transportation from the loading location to an unloading location, such as the loading dock of a customer, such as Wal-Mart. The method can also include the step of unloading the palletized fibrous structure from the loading means.

A method of displaying the rolled fibrous structure of the present invention can include the step of displaying (either on the pallet described above, or on a shelf) in a retail store at least one roll of fibrous structure, the roll having a roll density of at least about 0.12 grams per cubic centimeter. Additionally, the rolls of fibrous structure can comprise other parameters as described herein.

### Test Methods

Unless otherwise indicated, all tests described herein including those described under the Definitions section and the following test methods are conducted on samples, test equipment and test surfaces that have been conditioned in a conditioned room at a temperature of 73° F.±4° F. (about 23° C.±2.2° C.) and a relative humidity of 50%±10% for 12 hours prior to the test. Further, all tests are conducted in such conditioned room.

### CRT Test Method

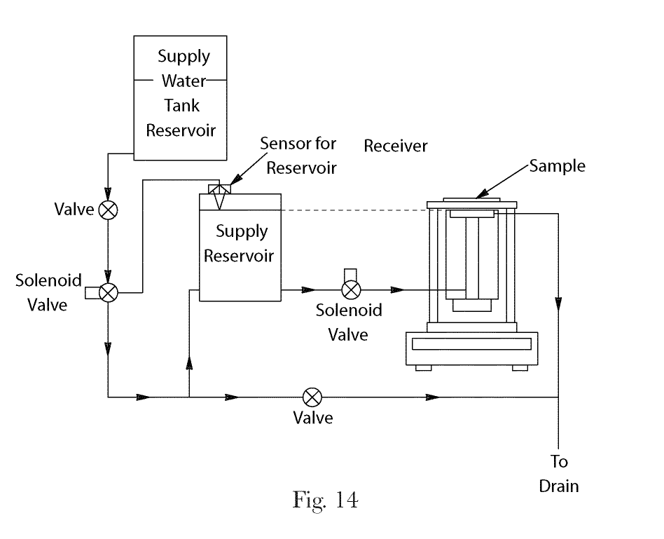

The CRT Test Method is described below and with reference to FIG. 14.

### Principle

The absorption (wicking) of water by a nonwoven sample is measured over time. The sample is supported by an open weave net structure that rests on a balance. The test is initiated when a tube connected to a water reservoir is raised and the meniscus makes contact with the sample. Absorption is allowed to occur for two seconds after which contact is broken and the cumulative rate for the first two seconds is calculated. Contact is reinitiated and the sample is allowed to absorb until it reaches saturation (defined as an uptake rate of 0.009 g/6 s): or less, or 300 seconds, whichever comes first.

### Scope

This method applies to the absorptive rate and capacity of paper towels and napkins at a negative head height of 2.0+/−0.2 mm. (Optionally, the instrument is capable of measurement of other head heights and real time absorption curve data may be collected for research purposes).

Note: This method does not include collection of real-time weight data during absorption. For such testing, see the notebook method in WHT 1576 for suggested instrument settings.

### Apparatus

Conditioned Room Temperature and humidity controlled within the following limits:
   Temperature: 73°±2° F. (23°±1° C.)
   Relative Humidity: 50±2%
Sample Cutter Alpha Precision Cutter model 240-10 (hydraulic) or model 240-7A (pneumatic); Thwing-Albert Instrument Co., 14 Collings Ave, West Berlin, N.J. 08091, 856-767-1000
Cutting Die Three inch (76.2 mm) diameter circular die with or without soft foam rubber insert material. Obtain from WDS Inc. 5115 Crookshank Rd. Cincinnati, Ohio 45233, 513-922-9459, (or equivalent).
Capacity Rate Tester (CRT) Absorbency tester capable of measuring capacity and rate. Consists of balance (0.001 g), on which rests a sample platform over a small reservoir with a delivery tube in the center. This reservoir is filled by the action of solenoid valves, which help to connect the sample supply reservoir to an intermediate reservoir, the water level of which is monitored by an optical sensor. Obtain from Integrated Technologies Engineering (ITE). 424 Wards Corner Rd. Loveland, Ohio 45140, 513-576-6200. See FIG. 1 for concept drawing.
Computer Software LabView based custom software specific to CRT Version 4.2 or later. Obtain from Wineman Technology Inc. (WTI). 1668 Champagne Dr. North Saginaw, Mich. 48604 (989)771-3000.

### Reagents

Water Distilled water must pass Analytical Method GCAS 58007262 “Distilled Water Quality”

### Sample Preparation

For this method, a usable unit is described as one finished product unit regardless of the number of plies. Condition all samples with packaging materials removed for a minimum of 2 hours prior to testing.

### Towels

Discard at least the first ten usable units from the roll. Remove two usable units and cut one 3 inch circular sample from the center of each usable unit for a total of 2 replicates for each test result. Up to 6 replicates may be cut at one time. If it is difficult to separate replicates without breaking the ply bond, the release paper may be placed between replicates before cutting and removed after. Do not write identification number in center of sample, since this may alter an emboss pattern.

Note: Do not test samples with defects such as wrinkles, tears, holes, etc. Replace with another usable unit which is free of such defects.

### Napkins

Select two (2) usable units from each package (or stack if not packaged) submitted for testing.

Cut one 3 inch circular sample from the center of each usable unit for a total of 2 replicates for each test result. Cut one usable unit at one time. Do not unfold the usable unit prior to cutting. Take care to keep the layers of the sample aligned as they were prior to cutting. Do not write identification number in center of sample, since this may alter an emboss pattern.

Note: Do not test samples with defects such as wrinkles, tears, holes, etc. Replace with another usable unit which is free of such defects.

### Operation

Record successful completion of all Instrument Set-Ups in Instrument Logbook

Record the calibration values (Weekly Instrument Set-Up steps 2f and 3k) in the instrument logbook.

### Weekly Instrument Set-Up

1. Check centering of supply tube relative to the stringing pattern.
   a. Click on the “Manual Control” tab.
   b. Raise tube to position 230.
   c. Look straight down on the pattern and tube. (A step stool or mirror may be necessary)
   d. Visually confirm that all four sides of the central square are directly above the tube lip.
   e. If the alignment is not correct, adjust by moving the plate that the balance sits on. See manufacturer directions.
2. Perform the “Tube Height Calibration” under the “System Setup” tab
   a. Set the “Threshold Weight” at 0.5 g
   b. Set the “Initial Tube Extension” at 220 steps
   c. Set the “Maximum Tube Extension” at 256 steps
   d. Click “Start Calibration”
   e. When prompted, place the sample cover onto the empty stringing pattern, close the balance windows, and click “OK”
   f. The instrument will move 1 step at a time and take a weight measurement. When finished it will enter the result into the “Tube Height” box. This is the height that the tube initiated contact with the stringing pattern, causing a change in measured weight. Record this value in the instrument logbook as the “Tube Height Calibration” for that week.
   g. If the height is not between 240 and 255, then follow the manufacturer's instructions for adjusting the receiver height. If this adjustment is made check that the tube is Level by placing a flat plate (preferably glass) and a bubble level on the tube lip.
   h. Repeat steps 2a-2 g until value is between 240 and 255 and tube lip is level.
3. Perform the “Water Height Calibration” under the “System Setup” tab
   a. Wipe off the outside of the supply tube with a Bounty paper towel. Do not get grease from the O-ring are onto the lip of the tube. Some force may be necessary to remove surfactant buildup.
   b. Wipe off the inside of the supply tube with a polyurethane foam swab. Some force may be necessary to remove surfactant buildup.
   c. Set the “Tube Initial Position” at 10-20 steps below the “Tube Height” from Step 2f
   d. Set the “Dwell Between Steps” at 1.0 sec
   e Click “Start Calibration”
   f. When prompted, remove sample pedestal and click “OK”
   g. When prompted to “Dry tube and place tool”, use a long-neck bulb type syringe to suction a full syringe of fluid from within the water delivery tube, dry the lip of the tube using a paper towel, place a 1″×1″ glass plate (frosted on both sides) on the lip, wait for the reservoir to finish filling, and click “OK”
   h. Keep the mouse cursor over the large button. The tube will lower one step every second. Immediately when water contact with the glass plate is visually confirmed, click on the large button to record the result in the “Water Height” box and end the calibration.
   i. Exit the Calibration to reinitialize the motor.
   j. Repeat steps 3a-3 g two additional times.
   k. Average the 3 calibrations. Record this value in the instrument logbook as the “Water Height Calibration” for that week.
   l. Subtract this average from the “Tube height” from step 2f. This value should be 42+/−6 steps.
   m. If the value is not between 36 and 48, first try cleaning the inside of the supply tube. If it is still out of range, then follow the manufacturer's instructions for adjusting the water level. (A half turn of the Allen bolt will result in approximately a 5 step change in water level.) Alternatively the “Tube Height” may be adjusted by turning the feet on the scale (A quarter turn of both scale feet will result in approximately a 5 step change in “Tube Height”). Stringing pattern level must remain acceptable and the “Tube Height must remain between 240 and 250(However the scale needs to remain level).
4. Change test profile parameters as indicated in Table 1.
5. Check that the System Setup parameters are set according to Table 2.

### Daily Instrument Set-Up

Record the verification values (Daily Instrument Verification steps 6f) in the instrument logbook.
1. Inspect the large Tank Reservoir to make sure it is adequately filled.
2. Turn instrument power on and open software, if necessary. The instrument will fill and level the water in the Supply Reservoir and the Receiver automatically.
3. Load the desired test profile and check that parameters match those shown in Table 1, based on the weekly calibration values (see Weekly Instrument Setup steps 2 and 3).
4. In the “System Setup” tab, make sure that “Level Control (While Testing)” is “on”.
5. Make sure there are no air bubbles in the tubing by using a long-neck bulb type syringe to quickly suction fluid from within the water delivery tube.
6. Perform the “Tube Height Calibration” under the “System Setup” tab
   a. Set the “Threshold Weight” at 0.5 g
   b. Set the “Initial Tube Extension” at 220 steps
   c. Set the “Maximum Tube Extension” at 256 steps
   d. Click “Start Calibration”
   e. When prompted, place the sample cover onto the empty stringing pattern, close the balance windows, and click “OK”
   f. The instrument will move 1 step at a time and take a weight measurement. When finished it will enter the result into the “Tube Height” box. This is the height that the tube initiated contact with the stringing pattern, causing a change in measured weight. Record this value in the instrument logbook as the “Tube Height Verification” for that day.
   g. Take this value and subtract the average “Water Height” from Weekly Calibration step 2k. This value should be 42+/−6 steps.
   h. If the value is not between 36 and 48, the system owner must correct the system as necessary.

### Sample Testing

1. Login
2. Select the desired tab:
   Rate Only—Select “Absorption Rate Test” tab.
   Capacity Only—Select “Absorption Capacity Test” tab
   Rate and Capacity—Select “Rate and Capacity Tests Combined” tab
3. Enter Sample Number and Click on the “Start Test” button.
4. When “Load Sample” appears, place the sample on the support rack, close the balance windows and click “OK”
   a. When placing the sample on the sample support rack, be sure the center of the sample coincides with the center of the rack
   b. Towel samples should be placed with the side of the sheet that was facing the outside of the roll down.
   c. Napkins may have either side of the product down, but the layers should be aligned as they were prior to cutting.
5. When “Place Top Screen” appears, open the top window: position the sample cover, close the window, and then click “OK”.
6. Allow the instrument to run the test type selected in step 1. The test will stop automatically at the predetermined point.
7. Remove the sample and thoroughly dry the support rack and sample cover.
8. Repeat the test with the second replicate.
9. When all samples have been tested save the data table (File—Data Table—Save As) and clear the data table (File—Data Table—Clear All Data Tables).
10. Logout

### Calculations

The software will display the following values for each sample replicate: Final Weight (g). Rate (g/s), Capacity Ratio (gig), and Capacity (g/sheet). The software calculates Capacity (g/sheet) based on 11″×11″ dimensions for Towels and 6″×6″ for Napkins.

When calculating Capacity (g/sheet) based on a different sheet size, then use the following equation:

Capacity (g/sheet)=0.14147×Final Weight (g of fluid absorbed)×Sheet Width (inches)×Sheet Length (inches)

Capacity (g/in²) can be calculated using the following equation:

Capacity (g/in²) 0.14147×Final Weight (g of fluid absorbed)

Note: 0.14147 is the inverse of the area of the 3 inch circle and converts values to a per square inch basis.

### Reporting Results

Report the results as designated in the Formula Card or submitter request.

Report the average cumulative 0-2 s rate to the nearest 0.001 g/s

Report the average capacity ratio to the nearest 0.01 g/g

Report the average capacity (g/in²) to the nearest 0.001 g/in²

Report the average capacity (g/sheet) to the nearest 0.01 g/sheet. Use the following guidelines to report Capacity (g/sheet):
Within manufacturing, report Capacity (g/sheet) calculated by the software (uses 11″×11″ dimensions for Towels and 6″×6″ for Napkins)
Within R&D (WHBC), the actual dimensions of the converted sheet are to be used to calculate Capacity (g/sheet).

TABLE 1
Test Profile Parameters

| | | |
|---|---|---|
| Parameter | Units | Value |

Rate

| | | |
|---|---|---|
| Motor Velocity | steps/sec | 260 |
| Pre-Test Extension | steps | [Value obtained from |
| | | “Water Height Calibration”] − 10 |
| Motor Full Extension | steps | [Value obtained from |
| | | “Tube Height Calibration”] − 10 |
| Start DAQ Extension | steps | 200 |
| Motor Pull-Back | steps | 0 |
| Supply Valve Delay | sec | 4 |
| Dwell | sec | 2 |
| Return Position | steps | 5 |

Capacity

| | | |
|---|---|---|
| Motor Velocity | steps/sec | 260 |
| Pre-Test Extension | steps | [Value obtained from |
| | | “Water Height Calibration”] − 10 |
| Motor Full Extension | steps | [Value obtained from |
| | | “Tube Height Calibration”] |
| Start DAQ Extension | steps | 200 |
| Motor Pull-Back | steps | 10 |
| Supply Valve Delay | sec | 4 |
| Rate Limit | sec | 0.0015 |
| Time Limit | sec | 500 |
| Return Position | steps | 5 |
| Rate Limit Enable | | Enabled |

Grams per Sheet Calculation

| | | |
|---|---|---|
| 1/Sample Area | in⁻² | 0.14147 |
| Sheet Length | in | (11 for Towel Manufacturing) |
| | | (6 for Napkin Manufacturing) |
| Sheet Width | in | (11 for Towel Manufacturing) |
| | | (6 for Napkin Manufacturing) |

TABLE 2
System Setup Parameters
Reservoir Level Control

| Parameter | Value |
|---|---|
| Level Control (while testing) | ON |

Capacity Test

| Parameter | Units | Value |
|---|---|---|
| Rate Time Period | sec | 1 |
| Weight Average Points | points | 30 |

### Embossment Depth Test Method

Embossment height is measured using a GFM Primos Optical Profiler instrument commercially available from GFMesstechnik GmbH, Warthestraβe 21, D14513 Teltow/Berlin, Germany. The GFM Primos Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 27×22 mm, and d) recording optics adapted to a measuring area of at least 27×22 mm; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Primos Optical Profiler system measures the surface height of a sample using the digital micro-mirror pattern projection technique. The result of the analysis is a map of surface height (z) vs. xy displacement. The system has a field of view of 27×22 mm with a resolution of 21 microns. The height resolution should be set to between 0.10 and 1.00 micron. The height range is 64,000 times the resolution.

To measure a fibrous structure sample do the following:

1. Turn on the cold light source. The settings on the cold light source should be 4 and C, which should give a reading of 3000K on the display;
2. Turn on the computer, monitor and printer and open the ODSCAD 4.0 Primos Software.
3. Select “Start Measurement” icon from the Primos taskbar and then click the “Live Pic” button.
4. Place a 30 mm by 30 mm sample of fibrous structure product conditioned at a temperature of 73° F.±2° F. (about 23° C.±1° C.) and a relative humidity of 50%±2% under the projection head and adjust the distance for best focus.
5. Click the “Pattern” button repeatedly to project one of several focusing patterns to aid in achieving the best focus (the software cross hair should align with the projected cross hair when optimal focus is achieved). Position the projection head to be normal to the sample surface.
6. Adjust image brightness by changing the aperture on the lens through the hole in the side of the projector head and/or altering the camera “gain” setting on the screen. Do not set the gain higher than 7 to control the amount of electronic noise. When the illumination is optimum, the red circle at bottom of the screen labeled “I.O.” will turn green.
7. Select Technical Surface/Rough measurement type.
8. Click on the “Measure” button. This will freeze on the live image on the screen and, simultaneously, the image will be captured and digitized. It is important to keep the sample still during this time to avoid blurring of the captured image. The image will be captured in approximately 20 seconds.
9. If the image is satisfactory, save the image to a computer file with “.omc” extension. This will also save the camera image file “.kam”.
10. To move the date into the analysis portion of the software, click on the clipboard/man icon.
11. Now, click on the icon “Draw Cutting Lines”. Make sure active line is set to line 1.
Move the cross hairs to the lowest point on the left side of the computer screen image and click the mouse. Then move the cross hairs to the lowest point on the right side of the computer screen image on the current line and click the mouse. Now click on “Align” by marked points icon. Now click the mouse on the lowest point on this line, and then click the mouse on the highest point on this line. Click the “Vertical” distance icon. Record the distance measurement. Now increase the active line to the next line, and repeat the previous steps, do this until all lines have been measured (six (6) lines in total. Take the average of all recorded numbers, and if the units is not micrometers, convert it to micrometers (μm). This number is the embossment height. Repeat this procedure for another image in the fibrous structure product sample and take the average of the embossment heights.

### Emboss Wall Angle Test Method

The samples of embossed fibrous structures and/or sanitary tissue products comprising an embossed fibrous structure (such as 1-ply, 2-ply, 3-ply and other multi-ply sanitary tissue products) to be tested are stored in flat sheet form for 3 weeks under two different loads, one with a load of 200 g/in² and another with a load of 400 g/in². The loads are removed and the samples and the samples are cut if necessary to an appropriate sample size with an embossed portion to be analyzed for the analyzing as follows. For example, the sample dimension should be 5 cm×5 cm or greater. The sample is then analyzed as described below.

A wall angle of an embossment in a fibrous structure can be measured using a GFM Mikrocad Optical Profiler instrument commercially available from GFMesstechnik GmbH, Warthestraβe 21, D14513 Teltow/Berlin, Germany. The GFM Mikrocad Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 44 mm×33 mm, and d) matching resolution recording optics; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Mikrocad Optical Profiler system measures the surface height of a sample using the digital micro-mirror pattern projection technique. The result of the analysis is a map of surface height (z) vs. xy displacement. The system has a field of view of 48×36 mm with a resolution of 29 microns. The height resolution should be set to between 0.10 and 1.00 micron. The height range is 64,000 times the resolution.

To measure the wall angle of a embossment in an embossed fibrous structure the following can be performed: (1) Turn on the cold light source. The settings on the cold light source should be 4 and C, which should give a reading of 3000K on the display; (2) Turn on the computer, monitor and printer and open the ODSCAD 4.0 or higher Mikrocad Software; (3) Select “Measurement” icon from the Mikrocad taskbar and then click the “Live Pic” button; (4) Place an embossed fibrous structure sample, of at least 5 cm by 5 cm in size, under the projection head and adjust the distance for best focus; (5) Click the “Pattern” button repeatedly to project one of several focusing patterns to aid in achieving the best focus (the software cross hair should align with the projected cross hair when optimal focus is achieved). Position the projection head to be normal to the fibrous structure sample surface; (6) Adjust image brightness by changing the aperture on the camera lens and/or altering the camera “gain” setting on the screen. Set the gain to the lowest practical level while maintaining optimum brightness so as to limit the amount of electronic noise. When the illumination is optimum, the red circle at bottom of the screen labeled “I.O.” will turn green; (7) Select Standard measurement type; (8) Click on the “Measure” button. This will freeze the live image on the screen and, simultaneously, the surface capture process will begin. It is important to keep the sample still during this time to avoid blurring of the captured images. The full digitized surface data set will be captured in approximately 20 seconds; (9) Save the data to a computer file with “.omc” extension. This will also save the camera image file “.kam”; (10) Export the file to the FD3 v1.0 format; 11) Measure and record at least three areas from each sample; 12) Import each file into the software package SPIP (Image Metrology, A/S, Hørsholm, Denmark); 13) Using the Averaging profile tool, draw a profile line perpendicular to linear embossment transition region. Expand the averaging box to include as much of the embossment as practical so as to generate and average profile of the embossment transition region (from top surface to the bottom of the embossment and backup to the top surface.). In the average line profile window, select a pair of cursor points. Place the first cursor of the pair on the wall at a point that is at approximately 33% of the depth of the embossment. Place the second cursor of the pair at a point that is approximately 66% of the depth of the embossment. Read out the wall angle from the cursor information display and record it. Repeat this measure for at least 6 wall angles per sample data file.

To move the surface data into the analysis portion of the software, click on the clipboard/man icon; (11) Now, click on the icon “Draw Lines”. Draw a line through the center of a region of features defining the texture of interest. Click on Show Sectional Line icon. In the sectional plot, click on any two points of interest, for example, a peak and the baseline, then click on vertical distance tool to measure height in microns or click on adjacent peaks and use the horizontal distance tool to determine in-plane direction spacing; and (12) for height measurements, use 3 lines, with at least 5 measurements per line, discarding the high and low values for each line, and determining the mean of the remaining 9 values. Also record the standard deviation, maximum, and minimum. For x and/or y direction measurements, determine the mean of 7 measurements. Also record the standard deviation, maximum, and minimum. Criteria that can be used to characterize and distinguish texture include, but are not limited to, occluded area (i.e. area of features), open area (area absent of features), spacing, in-plane size, and height. If the probability that the difference between the two means of texture characterization is caused by chance is less than 10%, the textures can be considered to differ from one another.

### Horizontal Full Sheet (HFS) Test Method

The Horizontal Full Sheet (HFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a horizontal position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the HFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 11 in. (27.9 cm) by 11 in. (27.9 cm)). The balance pan can be made out of a variety of materials. Plexiglass is a common material used.

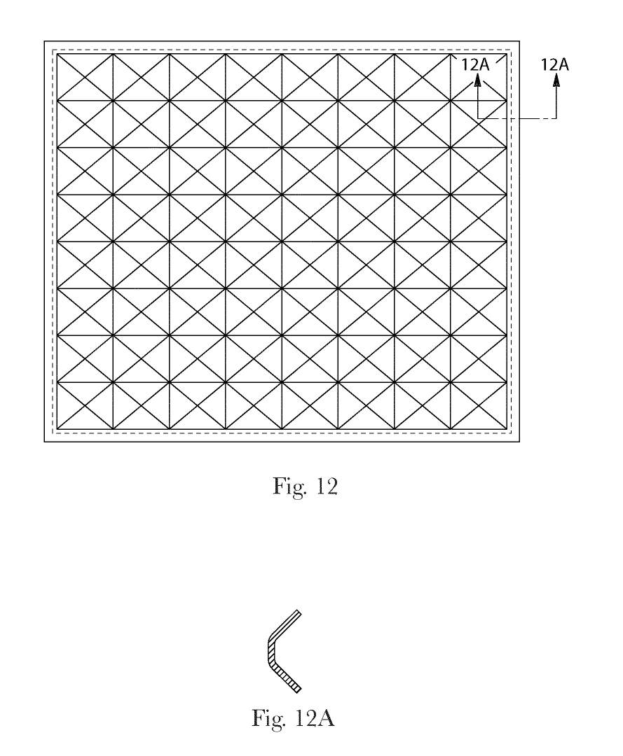

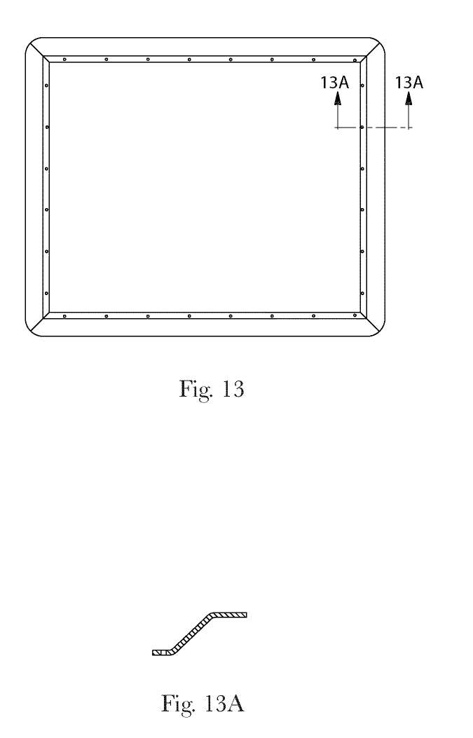

2) A sample support rack (FIG. 12) and sample support rack cover (FIG. 13) is also required. Both the rack and cover are comprised of a lightweight metal frame, strung with 0.012 in. (0.305 cm) diameter monofilament so as to form a grid as shown in FIG. 16. The size of the support rack and cover is such that the sample size can be conveniently placed between the two.

The HFS test is performed in an environment maintained at 23±1° C. and 50±2% relative humidity. A water reservoir or tub is filled with distilled water at 23±1° C. to a depth of 3 inches (7.6 cm).

Eight samples of a fibrous structure to be tested are carefully weighed on the balance to the nearest 0.01 grams. The dry weight of each sample is reported to the nearest 0.01 grams. The empty sample support rack is placed on the balance with the special balance pan described above.

The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack and cover are allowed to drain horizontally for 120±5 seconds, taking care not to excessively shake or vibrate the sample. While the sample is draining, the rack cover is carefully removed and all excess water is wiped from the support rack. The wet sample and the support rack are weighed on the previously tared balance. The weight is recorded to the nearest 0.01 g. This is the wet weight of the sample.

The gram per fibrous structure sample absorptive capacity of the sample is defined as (wet weight of the sample−dry weight of the sample). The horizontal absorbent capacity (HAC) is defined as: absorbent capacity=(wet weight of the sample−dry weight of the sample)/(dry weight of the sample) and has a unit of gram/gram.

### Vertical Full Sheet (VFS) Test Method

The Vertical Full Sheet (VFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a vertical position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the VFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 11 in. (27.9 cm) by 11 in. (27.9 cm)). The balance pan can be made out of a variety of materials. Plexiglass is a common material used.

2) A sample support rack (FIG. 12) and sample support rack cover (FIG. 13) is also required. Both the rack and cover are comprised of a lightweight metal frame, strung with 0.012 in. (0.305 cm) diameter monofilament so as to form a grid as shown in FIG. 16. The size of the support rack and cover is such that the sample size can be conveniently placed between the two.

The VFS test is performed in an environment maintained at 23±1° C. and 50±2% relative humidity. A water reservoir or tub is filled with distilled water at 23±1° C. to a depth of 3 inches (7.6 cm).

Eight 19.05 cm (7.5 inch)×19.05 cm (7.5 inch) to 27.94 cm (11 inch)×27.94 cm (11 inch) samples of a fibrous structure to be tested are carefully weighed on the balance to the nearest 0.01 grams. The dry weight of each sample is reported to the nearest 0.01 grams. The empty sample support rack is placed on the balance with the special balance pan described above. The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack and cover are allowed to drain vertically for 60±5 seconds, taking care not to excessively shake or vibrate the sample. While the sample is draining, the rack cover is carefully removed and all excess water is wiped from the support rack. The wet sample and the support rack are weighed on the previously tared balance. The weight is recorded to the nearest 0.01 g. This is the wet weight of the sample.

The procedure is repeated for with another sample of the fibrous structure, however, the sample is positioned on the support rack such that the sample is rotated 90° compared to the position of the first sample on the support rack.

The gram per fibrous structure sample absorptive capacity of the sample is defined as (wet weight of the sample−dry weight of the sample). The calculated VFS is the average of the absorptive capacities of the two samples of the fibrous structure.

### Roll Diameter and Percent Roll Compressibility Test Method

The Roll Diameter Tester is comprised of two perpendicularly attached flat metal plates each with a width of 6 inches to about 12 inches and length of about 1.5 ft. to about 3 ft. The bottom (horizontal) plate rests on a flat countertop and the other plate extends vertically therefrom. The top of the vertical plate has a shaft where the core of the rolls slides in so that the core is orientated parallel to the bottom plate. Above the shaft is a bar that is parallel to the shaft and also extends above the shaft to support the diameter tape. The 100 gram weight, with two hooks (one on each end), is attached to the roll diameter tape that hangs below the roll, and the second hook is used to attach the 1000 gram weight used to determine the Compressed Roll Diameter.

The diameter tape may be any commercially available diameter tape where one side is graduated, for example, in 16ths of an inch and is a standard ruler. The other side is used to measure diameters and is graduated in 100ths of an inch. For example, tape may be graduated so that the circumference of the cylindrical object is divided by the mathematical constant pi, the resulting diameter is plotted on the rule such that Diameter=Circumference/pi.

Percent of Roll Compressibility (Percent Compressibility) is determined as follows. Measure Original Roll Diameter on a roll which has a smooth tail sheet laying flat across the roll. Place the roll on the Roll Diameter Tester so that the end of the roll is flush with the vertical side plate of the tester. The tail sheet perforated edge should come off the top of the roll and be facing the grader. Attach the diameter tape to the bar and then loop the diameter tape around the circumference of the roll at the center of the roll and let the weighted end hang freely, having 100 gram weight. Wait 3 seconds and record the Original Roll Diameter measurement to the nearest 0.01 inch. With the diameter tape still in place, hang an additional 1000 gram weight for a total of 1,100 grams, to measure the Compressed Roll Diameter. Wait 3 seconds and record the reading on the tape to the nearest 0.01 inch. Calculate percent compressibility to the nearest 0.1% according to:

% Compressibility=[Original Roll Diam.−Compressed Roll Diam.]/(Original Roll Diam.)×100

To determine the Percent Compressibility take an average of 10 roll samples.

### Sheet Caliper Test Method

Sheet Caliper or Caliper of a sample of fibrous structure product is determined by cutting a sample of the fibrous structure product such that it is larger in size than a load foot loading surface where the load foot loading surface has a circular surface area of about 3.14 in². The sample is confined between a horizontal flat surface and the load foot loading surface. The load foot loading surface applies a confining pressure to the sample of 14.7 g/cm² (about 0.21 psi). The caliper is the resulting gap between the flat surface and the load foot loading surface. Such measurements can be obtained on a VIR Electronic Thickness Tester Model II available from Thwing-Albert Instrument Company, Philadelphia, Pa. The caliper measurement is repeated and recorded at least five (5) times so that an average caliper can be calculated. The result is reported in mils.

### Effective Caliper Test Method

Effective caliper of a fibrous structure in roll form is determined by the following equation:

EC=(RD²−CD²)/(0.00127×SC×SL)

wherein EC is effective caliper in mils of a single sheet in a wound roll of fibrous structure; RD is roll diameter in inches; CD is core diameter in inches; SC is sheet count; and SL is sheet length in inches.

### Roll Density Test Method

Roll Density of a fibrous structure in roll form is determined by the following equation:

Roll Density=BW*SC*SL/(Pi*108000*(RD²−CD²))

Wherein roll density is in units of lb/in³
and BW=basis weight of the product in #/3000 ft², RD is roll diameter in inches; CD is core diameter in inches; SC is sheet count; and SL is sheet length in inches.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A roll of fibrous structure, the fibrous structure being embossed and having a basis weight of less than about 45 pounds per 3000 square feet, wherein said roll has a roll diameter greater than about 6.5 inches and a roll density of greater than about 0.09 grams per cubic centimeter.

2. The roll of claim 1, wherein said fibrous structure has a dispensed to effective caliper ratio of greater than about 1.01.

3. The roll of claim 1, wherein the fibrous substrate comprises a continuous web of through-air-dried paper, said web having a length greater than about 1000 inches.

4. The roll of claim 1, wherein the fibrous substrate comprises a continuous web of through-air-dried paper, said continuous web comprising periodic lines of perforation, said lines of perforation defining sheets of fibrous substrate, each said sheet having a surface area of at least 700 square centimeters, wherein said roll comprises at least 100 of said sheets.

5. The roll of claim 1, wherein the fibrous substrate comprises a continuous web of through-air-dried paper, said continuous web comprising periodic lines of perforation, said lines of perforation defining sheets of fibrous substrate, each said sheet having a surface area of at least 400 square centimeters, wherein said roll comprises at least 170 of said sheets.

6. The roll of claim 1, wherein said fibrous substrate comprises a continuous web of paper wound into a roll having a roll compressibility of between about 1.9% and about 5.1%, wherein said paper can be dispensed by unrolling from said roll, and said paper has a dispensed absorptive capacity of from about 0.52 to about 0.7 g/121 square inches.

7. The roll of claim 1, wherein said fibrous substrate comprises a continuous web of embossed paper, said web having a length greater than about 1000 inches, wherein said embossments comprise a line embossment, said line embossment comprising side walls, and said side walls having a dispensed side wall angle of at least about 27 degrees.

8. A roll of fibrous structure, the fibrous structure having a dispensed to effective caliper ratio of greater than about 1.01.

9. The roll of claim 8, wherein said fibrous structure comprises embossed paper having a basis weight of less than about 45 pounds per 3000 square feet, and wherein said roll has a roll diameter greater than about 6.5 inches.

10. The roll of claim 8, wherein said fibrous substrate comprises a continuous web of through-air-dried paper, said web having a length greater than about 1000 inches and the roll having a diameter greater than about 6.5 inches.

11. The roll of claim 8, wherein said fibrous substrate comprises periodic lines of perforation, the lines of perforation defining sheets of fibrous substrate, each said sheet having a surface area of at least 700 square centimeters, wherein said roll comprises at least 100 of said sheets of fibrous substrate.

12. The roll of claim 8, wherein said fibrous substrate comprises periodic lines of perforation, the lines of perforation defining sheets of fibrous substrate, each said sheet having a surface area of at least 400 square centimeters, wherein said roll comprises at least 170 of said sheets of fibrous substrate.

13. The roll of claim 8, wherein said fibrous substrate comprises a continuous web of through-air-dried paper wound into a roll having a roll compressibility of between about 1.9% and about 5.1%, wherein said through-air-dried paper can be dispensed by unrolling from said roll, and said through-air-dried paper has a dispensed absorptive capacity of from about 0.52 to about 0.7 g/121 square inches.

14. A roll of fibrous substrate, the fibrous substrate being a continuous web of through-air-dried paper, said web having a length greater than about 1000 inches and the roll having a diameter greater than about 6.5 inches.

15. The roll of claim 14, wherein said fibrous structure has a dispensed to effective caliper ratio of greater than about 1.01.

16. The roll of claim 14, wherein said continuous web comprises periodic lines of perforation, said lines of perforation defining sheets of fibrous substrate, each said sheet having a surface area of at least 700 square centimeters, wherein said roll comprises at least 100 of said sheets.

17. The roll of claim 14, wherein said continuous web comprises periodic lines of perforation, said lines of perforation defining sheets of fibrous substrate, each said sheet having a surface area of at least 400 square centimeters, wherein said roll comprises at least 170 of said sheets.

18. The roll of claim 14, wherein said fibrous substrate comprises a continuous web of paper wound into a roll having a roll compressibility of between about 1.9% and about 5.1%, wherein said paper can be dispensed by unrolling from said roll, and said paper has a dispensed absorptive capacity of from about 0.52 to about 0.7 g/121 square inches.

19. The roll of claim 14, wherein said fibrous substrate comprises embossments, and wherein said embossments comprise a line embossment, said line embossment comprising side walls, and said side walls having a dispensed side wall angle of at least 27 degrees.

20. A roll of fibrous substrate, the fibrous substrate having periodic lines of perforation, the lines of perforation defining sheets of fibrous substrate, each said sheet having a surface area of at least 700 square centimeters, wherein the roll comprises at least 100 of said sheets of fibrous substrate and said roll has a diameter of at least about 6.5 inches.

21. A fibrous substrate, said fibrous substrate being a continuous web of through-air-dried paper wound into a roll having a roll compressibility of between about 1.9% and about 5.1%, wherein said through-air-dried paper can be dispensed by unrolling from said roll, and said through-air-dried paper has a dispensed absorptive capacity of from about 0.52 to about 0.7 g/121 square inches.

22. A roll of dispensable fibrous substrate, the fibrous substrate being a continuous web of through-air-dried, embossed paper, the web having a length greater than about 1000 inches and the roll having a diameter greater than about 6.5 inches, wherein said embossments comprise a line embossment, said line embossment comprising side walls, and said side walls having a dispensed side wall angle of at least 27 degrees.

23. A roll of dispensable fibrous substrate, the fibrous substrate being a continuous web of through-air-dried, embossed paper, the web having a length greater than about 1000 inches and the roll having a diameter greater than about 6.5 inches, wherein said embossments comprise a line embossment, said line embossment comprising a depth, and said depth after dispensing being at least 662 microns.

24. A method of economically transporting a fibrous substrate, the method comprising the steps of:
a. providing at a loading location a pallet having palletized thereon said fibrous substrate, said fibrous substrate being in the form of a plurality of rolls of through-air-dried paper, said paper being in the form of a continuous web, each said roll having a roll density of at least about 0.12 grams per centimeter;
b. loading said palletized fibrous substrate onto a means of transportation;
c. moving said means for transportation from said loading location to an unloading location;
d. unloading said palletized fibrous substrate from said loading means.

25. The method of claim 24, wherein, wherein said fibrous substrate has a dispensed to effective caliper ratio of greater than about 1.01.

26. The method of claim 24, wherein, each said roll of said fibrous substrate comprises a continuous web of through-air-dried paper, said web having a length greater than about 1000 inches.

27. The method of claim 24, wherein, said fibrous substrate comprises a continuous web of through-air-dried paper, said continuous web comprising periodic lines of perforation, said lines of perforation defining sheets of fibrous substrate, each said sheet having a surface area of at least 700 square centimeters, wherein said roll comprises at least 100 of said sheets.

28. The method of claim 24, wherein said fibrous substrate comprises a continuous web of paper wound into a roll having a roll compressibility of between about 1.9% and about 5.1%, wherein said paper can be dispensed by unrolling from said roll, and said paper has a dispensed absorptive capacity of from about 0.52 to about 0.7 g/121 square inches.

29. The method of claim 24, wherein each said pallet of said fibrous substrate has a pallet density of less than about 0.12 grams per cubic centimeter.

30. A fibrous structure comprising a fibrous web substrate comprising at least 0.5% by weight of polyquat.

31. The fibrous web of claim 30 wherein said fibrous web substrate is a TAD web.

32. The fibrous web of claim 30 wherein said fibrous web substrate is embossed.

33. The fibrous web of claim 30 wherein said fibrous web substrate is rolled into a roll of fibrous structure.

34. The fibrous web of claim 30 wherein said fibrous web substrate is rolled into a roll of fibrous structure and said roll has a roll density of at least about 0.09.

35. A roll of fibrous substrate, the fibrous substrate being a continuous web of through-air-dried paper having a dispensed bulk (defined as dispensed caliper (inches) divided by basis weight, multiplied by 1,000) of at least about 0.8 and a winding density (defined as web length per roll (inches) divided by roll diameter (inches) of at least about 200.

36. The roll of claim 35, wherein said fibrous structure has a dispensed to effective caliper ratio of greater than about 1.01.

37. The roll of claim 35, wherein the fibrous substrate comprises a continuous web of through-air-dried paper, said web having a length greater than about 1000 inches.

38. The roll of claim 35, wherein the fibrous substrate comprises a continuous web of through-air-dried paper, said continuous web comprising periodic lines of perforation, said lines of perforation defining sheets of fibrous substrate, each said sheet having a surface area of at least 700 square centimeters, wherein said roll comprises at least 100 of said sheets.

39. The roll of claim 35, wherein the fibrous substrate comprises a continuous web of through-air-dried paper, said continuous web comprising periodic lines of perforation, said lines of perforation defining sheets of fibrous substrate, each said sheet having a surface area of at least 400 square centimeters, wherein said roll comprises at least 170 of said sheets.

40. The roll of claim 35, wherein said fibrous substrate comprises a continuous web of paper wound into a roll having a roll compressibility of between about 1.9% and about 5.1%, wherein said paper can be dispensed by unrolling from said roll, and said paper has a dispensed absorptive capacity of from about 0.52 to about 0.7 g/121 square inches.

41. The roll of claim 35, wherein said fibrous substrate comprises a continuous web of embossed paper, said web having a length greater than about 1000 inches, wherein said embossments comprise a line embossment, said line embossment comprising side walls, and said side walls having a dispensed side wall angle of at least about 27 degrees.
